(19) United States
(12) Patent Application Publication
(10) Pub. No.: US 2024/0272075 A1
(43) Pub. Date: Aug. 15, 2024

(54) TAGGANT SYSTEMS AND METHODS OF USE

(71) Applicant: University of Northern Iowa Research Foundation, Cedar Falls, IA (US)

(72) Inventors: Curtiss Dwight Hanson, Cedar Falls, IA (US); Colin Weeks, Cedar Falls, IA (US)

(21) Appl. No.: 18/534,984

(22) Filed: Dec. 11, 2023

Related U.S. Application Data
(60) Provisional application No. 63/484,379, filed on Feb. 10, 2023.

(51) Int. Cl. G01N 21/64

(52) U.S. Cl. CPC G01N 21/6428; G01N 2021/6439

(57) ABSTRACT

The present disclosure relates generally to a taggant system based on adsorbing at least two different metal elements in varying proportions into an inert encapsulating material, wherein the combination of metal elements and/or proportion of metal elements is an identifying marker of the taggant. The taggants can be uniquely identified by the metal elements it contains and/or the quantitation of their relative proportions. The taggants are stable, are quickly and easily identified, do not degrade or interact with the tagged material, can be designed to not degrade in extreme environments, and have a detection based on the emission of electromagnetic radiation that permits detection at trace levels.

### CROSS-REFERENCE TO RELATED APPLICATION

This application claims priority under 35 U.S.C. § 119 to Provisional Application U.S. Ser. No. 63/484,379, filed on Feb. 10, 2023, which is herein incorporated by reference in its entirety including without limitation, the specification and claims, as well as any figures, tables, or examples thereof.

### TECHNICAL FIELD

The present disclosure relates generally to a taggant system based on adsorbing multiple metal elements in varying proportions into the pores of an inert material such as a zeolite. The taggants can be uniquely identified by the metal elements it contains and the quantitation of their relative proportions. The taggants are stable, do not degrade in extreme environments, and have a detection based on the emission of electromagnetic radiation that permits detection at trace levels.

### BACKGROUND

Methods for rapid and specific identification of objects are increasingly important in today's society, for example for managing inventory or tracking parcels. Taggant is the term used to describe materials that are uniquely encoded and used to quickly identify and track tagged items. Taggants are currently used in a wide range of applications and industries including explosives, food and grain and agriculture, currency, and pharmaceuticals.

Generally, to be a functional taggant, the material must provide the capacity to create a wide range of unique sequences or patterns to encode the identity and must not interact with the substance to be traced. It also must provide quick identification of the encoded identity and be difficult to counterfeit or duplicate. Currently available taggant systems may provide this type of performance, but typically for a narrow range of applications, or require the material be returned to a specific laboratory for analysis and identification. For example, using biomarkers created from specific protein sequences can provide a wide array of digital encoding, but requires that the samples are returned and analyzed at a dedicated laboratory that is capable of isolating and sequencing the protein. Additionally, many currently available systems such as microchips are limited in the environment in which they can be applied due to thermal or chemical degradation or interaction with the material being tagged.

There exists a need for a simple taggant system that will not degrade in extreme environments, that permits detection at trace levels, is quickly and easily identified, and does not degrade or interact with the tagged material.

### SUMMARY

The present disclosure provides an identification system comprising a taggant comprising at least two different metal elements adsorbed into an inert encapsulating material, wherein the combination of metal elements and/or proportion of metal elements is an identifying marker of the taggant. In an embodiment, the metal elements are metal ions and the inert encapsulating material is a zeolite. In an embodiment, the relative concentration of the different metal elements is varied by about 5% or more to create the identifying marker of the taggant. In an embodiment, the identification system is non-toxic. In an embodiment the identification system comprises a coating to reduce variation in the identifying marker of the taggant in a harsh environment and/or to prevent tampering with the taggant. In an embodiment, the identification system is incorporated into a thin layer or a coating of an object to be identified. In an embodiment, the identification system is enclosed between two thin layers.

The present disclosure also provides a method of making the identification system comprising adsorbing at least two different metal elements into an inert encapsulating material, wherein a pre-selected combination of metal elements and/or a pre-selected proportion of metal elements is the identifying marker of the taggant.

The present disclosure also provides systems and objects comprising the identification system.

The present disclosure also provides a method of identifying an object comprising applying the identification system to an object, and detecting the combination of metal elements and/or proportion of metal elements in the taggant. In an embodiment, detecting the metal elements and/or proportion of metal elements is non-destructive to the taggant. In an embodiment, detecting the metal elements and/or proportion of metal elements in the taggant is conducted on-site. In an embodiment, detecting comprises x-ray fluorescence.

These and/or other objects, features, advantages, aspects, and/or embodiments will become apparent to those skilled in the art after reviewing the following brief and detailed descriptions of the drawings. The present disclosure encompasses combinations of disclosed aspects and/or embodiments and/or reasonable modifications not shown or described.

### BRIEF DESCRIPTION OF THE DRAWINGS

The patent or application file contains at least one drawing executed in color. Copies of this patent or patent application publication with color drawing(s) will be provided by the Office upon request and payment of the necessary fec.

FIG. 1 is an illustration of three taggants each with unique identifying signatures created by varying the composition and relative concentration of the metal ions adsorbed into a zeolite matrix.

FIG. 2 shows a photograph of (a) zeolite ZSM-5, (b) zeolite ZSM-5 with Co adsorbed into it, and (c) zeolite ZSM-5 with Co adsorbed into it and coated by coking.

FIG. 3 shows the XRF spectrum of a zeolite sample adsorbed with strontium and cobalt before the sample was coated with a layer of carbon.

FIG. 4 shows the XRF spectrum of a zeolite sample adsorbed with strontium and cobalt after the sample was coated with a layer of carbon.

FIG. 5 is a photograph of a lead bullet coated with a composite epoxy urethane that was tagged with strontium nitrate after it was fired and recovered.

FIG. 6 is a photograph of a lead bullet coated with a composite epoxy urethane that was tagged with ZSM-5/Sr taggant material after it was fired and recovered.

FIG. 7 is a graph of solution concentration of strontium desorbed from uncoated ZSM-5/Co/Sr taggant material in solutions of distilled water, 0.5 M ammonia, and 0.1M hydrochloric acid.

FIG. 8 is a graph of solution concentration of cobalt desorbed from uncoated ZSM-5/Co/Sr taggant material in solutions of distilled water, 0.5 M ammonia, and 0.1M hydrochloric acid.

FIG. 9 is a graph of solution concentration of calcium desorbed from uncoked and coked ZSM-5/Ca taggant samples in 0.1 M hydrochloric acid or water.

FIG. 10 is a graph of solution concentration of manganese desorbed from uncoked and coked ZSM-5-Mn taggant samples in 0.1 M hydrochloric acid or water.

FIG. 11 is a photograph of samples with acrylic paint with different proportions of the ZSM-5/Co/Sr taggant: (a) is a filter paper control with no added paint; (b) is acrylic paint only; (c) is acrylic paint with 10% ZSM-5/Co/Sr taggant; and (d) is acrylic paint with 27% ZSM-5/Co/Sr taggant.

FIG. 12 is a photograph of samples with oil paint with different proportions of the ZSM-5/Co/Sr taggant: (a) is oil paint only; (b) is oil paint with 10% ZSM-5/Co/Sr taggant; (c) is oil paint with 26% ZSM-5/Co/Sr taggant; and (d) is oil paint with 25% ZSM-5/Co/Sr taggant.

FIG. 13 is a photograph of samples with oil paint with different proportions of the ZSM-5/Fc/Ni or the ZSM-5/Co/Cu taggant: (a) is oil paint only; (b) is oil paint with 25% ZSM-5/Fc/Ni taggant; (c) is oil paint with 10% ZSM-5/Fe/Ni taggant; (d) is a filter paper control with no added paint; (c) is oil paint with 10% ZSM-5/Co/Cu taggant; and (f) is oil paint with 25% ZSM-5/Co/Cu taggant.

FIG. 14 is a photograph of samples with acrylic paint with different proportions of the ZSM-5/Fe/Ni or the ZSM-5/Co/Cu taggant: (a) is a filter paper control with no added paint; (b) is acrylic paint only, spread out evenly using microscope slides; (c) is acrylic paint with 25% ZSM-5/Fc/Ni taggant; (d) is acrylic paint with 10% ZSM-5/Co/Cu taggant; (c) is an uneven coating of acrylic paint only; (f) is acrylic paint with 10% ZSM-5/Fe/Ni taggant; and (g) is acrylic paint with 25% ZSM-5/Co/Cu taggant.

FIG. 15 is a photograph of writing samples made with (a) a mixture of black pen ink and a ZSM-5/Co/Sr taggant, and (b) a control sample with black pen ink only, and no taggant.

FIG. 16 is a photograph of writing samples made with (a) a control sample with black toner only, and no taggant, and (b) a mixture of black toner and a ZSM-5/Co/Sr taggant.

FIG. 17 is a photograph of red cotton swatches, wherein (a) is a control sample of fabric only and (b) is a red cotton swatch with a ZSM-5/Co/Sr taggant in water slurry applied to the surface.

FIG. 18 is a photograph of the reverse side of the red cotton swatches in FIG. 17, wherein (a) is a control sample of fabric only and (b) is a red cotton swatch with a ZSM-5/Co/Sr taggant in water slurry applied to the surface.

FIG. 19 is a photograph of the polyethylene bags, wherein (a) is a control sample of a polyethylene bag, and (b) is a polyethylene bag with ZSM-5/Co/Sr taggant inside the bag.

FIG. 20 shows photographs of 0.50 inch spherical bullets (a) with Hi-Tek polymer coating, and (b) with Hi-Tek polymer coating plush ZSM-5/Co/Sr taggant coating.

FIG. 21 shows photographs of 0.50 inch spherical control bullets with Hi-Tek polymer coating after firing into a book.

FIG. 22 shows photographs of 0.50 inch spherical control bullets with Hi-Tek polymer coating plus ZSM-5/Co/Sr taggant after firing into a book.

FIG. 23 shows photographs of corn kernels (a) as received, (b) glucose coated control, and (c) coated with glucose and the ZSM-5/Co/Sr taggant.

FIG. 24 shows photographs of corn plants 11 days after planting grown from kernels that were (a) used as received, (b) glucose treated controls, and (c) glucose+ZSM-5/Co/Sr taggant coated.

FIG. 25 shows photographs of plants grown from kernels that were (a) used as received, (b) glucose treated controls, and (c) glucose+ZSM-5/Co/Sr taggant coated.

Various embodiments of the present invention will be described in detail with reference to the drawings, wherein like reference numerals represent like parts throughout the several views. Reference to various embodiments does not limit the scope of the invention. Figures represented herein are not limitations to the various embodiments according to the invention and are presented for exemplary illustration of the invention.

### DETAILED DESCRIPTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated. It is further to be understood that all terminology used herein is for the purpose of describing particular embodiments only, and is not intended to be limiting in any manner or scope.

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable, for example mass, pH, percentage, temperature, ratios, concentration, volume, and the like. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

Terms characterizing sequential order, a position, and/or an orientation are not limiting and are only referenced according to the views presented.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

Numeric ranges recited within the specification are inclusive of the numbers within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range (e.g. 1 to 5 includes 1, 1.5, 2, 2.75, 3, 3.80, 4, and 5).

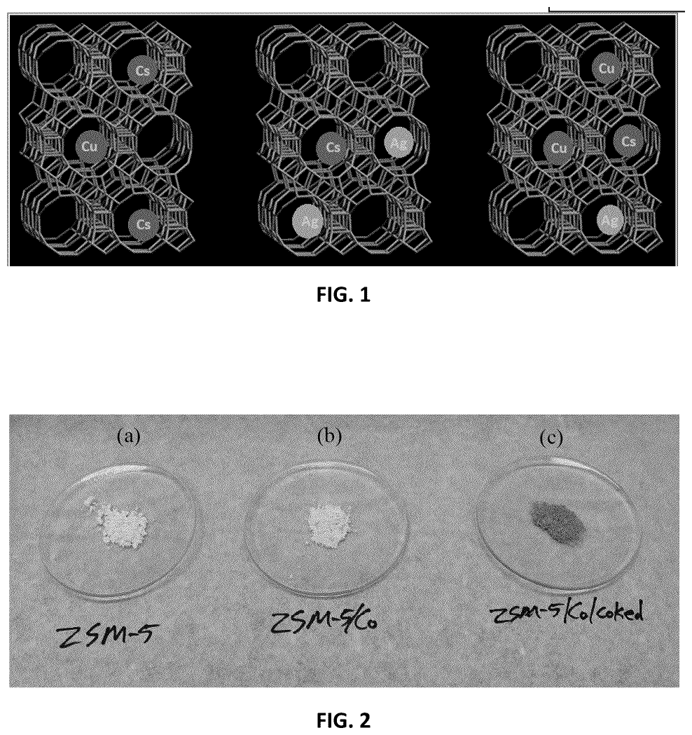

The present disclosure provides a taggant based on an inert, encapsulating material into which metals are adsorbed. A unique taggant signature is created by varying the metals in the taggant as well as their relative concentration within the matrix. Exemplary taggants are illustrated in FIG. 1. FIG. 1 illustrates three different taggants, each with a unique identifying signature created by varying the composition of metal ions and the relative concentration of the differing metal ions in a zeolite encapsulating material.

### A Taggant/Identification System

As used herein, an identification system refers to a system for identifying and/or detecting an object and may refer to a taggant itself and/or a system comprising a taggant.

The present disclosure provides an identification system comprising a taggant, wherein the taggant comprises at least two different metal elements adsorbed into an inert encapsulating material and wherein the combination of metal elements and/or proportion of metal elements is the identifying marker of the taggant. In an embodiment, it is the specific combination of metal elements that is the identifying marker of the taggant. In an embodiment, it is the proportion of metal elements that is the identifying marker of the taggant. In an embodiment, it is both the specific metal elements and the relative proportion of those metal elements that is the identifying marker of the taggant. As used herein, relative proportion, proportion, and ratio all refer to amounts of different metals relative to each other and include measurements based on weight, concentration, number of atoms, and the like. In an embodiment, the proportion of metal elements is based on weight ratios. In an embodiment, the metal elements comprise calcium, cerium, chromium, cobalt, copper, iron, lanthanum, manganese, nickel, and/or strontium.

The inert encapsulating material may comprise any inert material capable of adsorbing metal elements as known in the art. In an embodiment, the inert encapsulating material comprises a zeolite. In an embodiment, the inert encapsulating material is zeolite. Zeolites comprise aluminum and silicon atoms linked together by oxygen atoms into polymeric networks. This aluminosilicate network is negatively charged, and most have a porous structure making it relatively easy to incorporate varying metal cations into zeolites to balance the negative charge. This disclosure is not meant to be limited to zeolites. In an embodiment, the inert encapsulating material comprises carbon nanotubes, clays, fullerenes, graphite, graphene, a polymer, a porous metal oxide, and the like. In an embodiment, the polymer may be any porous or non-porous polymers as known in the art. Exemplary porous polymers include, but are not limited to, covalent organic frameworks, hypercrosslinked polymers, conjugated microporous polymers, polymers of intrinsic microporosity, macroporous polymers from high internal phase emulsions, foams, coordination polymers, and the like.

In an embodiment, the inert encapsulating material is included as an identifying marker of the taggant, in addition to the specific metal elements and/or the relative proportion of those metal elements. As disclosed herein, the inert incapsulating material may comprise any inert material capable of adsorbing metal elements and therefore the selection of the specific inert incapsulating material may also be an identifying marker of the taggant.

In an embodiment, the metal elements adsorbed into the inert encapsulating material comprise metal ions. In an embodiment, the inert encapsulating material comprises zeolite, and the metal elements adsorbed into the zeolite comprise metal ions.

In an embodiment, the relative concentration of different metal elements adsorbed into the inert encapsulating material is varied by about 5% or more to create an identifying marker of the taggant. In an embodiment, the relative concentration of different metal elements adsorbed into the inert encapsulating material is varied by about 10% or more to create an identifying marker of the taggant.

In an embodiment, the proportion of metal elements is an identifying marker of the taggant, and the taggant comprises from 2 different metal elements to 10 different metal elements, or more. In an embodiment, the number of different elements in the taggant is related to the desired level of encryption of the taggant and/or the sensitivity of the detection method.

In an embodiment, the combination of metal elements is an identifying marker of the taggant, and the taggant comprises 3 or more different metal elements. In an embodiment, the number of different elements in the taggant is related to the desired level of encryption of the taggant and/or the sensitivity of the detection method.

In an embodiment, the identification is non-toxic. As used herein, non-toxic refers to a material that is safe for human and/or animal interaction without harmful effects. As known in the art, a non-toxic substance may comprise elements that may be toxic at certain, often larger, dosages, but is not toxic at the amount within the substance.

In an embodiment, the identification system further comprises a coating on at least a portion of the taggant. In an embodiment, the coating is inert. In an embodiment, the coating blocks the pores of the inert encapsulating material. In an embodiment, the coating blocks the pores of the inert encapsulating material such that the identifying marker of the taggant remains usable for its intended purpose. Such a coating would protect against tampering of the taggant and/or allow its use in environments that would otherwise inhibit the use of the taggant. In an embodiment, the coating reduces variation in the identifying marker of the taggant. In an embodiment, the coating reduces variation in the identifying marker of the taggant that would otherwise render the taggant unusable for its intended purpose. In an embodiment, the coating reduces variation of the taggant in a harsh environment. As used herein, a harsh environment refers to an environment wherein the conditions therein alter the identifying marker of the taggant sufficient to impede the use of the taggant. In an embodiment, a harsh environment comprises a pH of less than about 5 or a pH of greater than about 9. In an embodiment, a harsh environment comprises a temperature of greater than about 50° C., or greater than about 100° C. In an embodiment, a harsh environment is highly oxidizing or highly reducing, sufficient to interfere with the identifying marker of the taggant and impede its use. In an embodiment, the coating comprises carbon, polymer, plastic, oxidation and/or acid resistant metal, metal oxide, metalloid oxide, and the like.

In an embodiment, the coating is included as an identifying marker of the taggant, in addition to the specific metal elements and/or the relative proportion of those metal elements. In an embodiment, the selection of the specific coating the taggant comprises is an identifying marker of the taggant.

In an embodiment, the identification system comprises from about 1 wt-% to about 50 wt-% of a taggant. In an embodiment, the identification system comprises more than about 50 wt-% of a taggant.

In an embodiment, the identification system is a thin layer on at least a portion of an object. In an embodiment, the identification system is incorporated into a layer coating at least a portion of an object. In an embodiment, the identification system is incorporated into a paint, an ink, a pigment, a dye, a polymer, a plastic, an opacifier, and/or an adhesive on at least a portion of an object. In an embodiment, the identification system is less than 1 mm in thickness. In an embodiment, the identification system is greater than 1 mm in thickness. In an embodiment, the identification system is enclosed between two layers. In an embodiment, the identification system is enclosed between two layers, wherein the layers comprise plastic and/or polymer. In an embodiment, the identification system is enclosed between two layers, wherein the layers comprise polyethylene.

### A Method of Making the Identification System

This disclosure provides a method of making the identification systems disclosed herein. In an embodiment, a method of making the identification system disclosed herein comprises adsorbing at least two different metal elements into an inert encapsulating material, wherein a pre-selected combination of metal elements and/or a pre-selected proportion of metal elements is the identifying marker of the taggant. In an embodiment, a method of making the identification system disclosed herein comprises adsorbing at least two different metal elements into an inert encapsulating material, wherein a pre-selected combination of metal elements and/or a pre-selected proportion of metal elements and/or pre-selected inert encapsulating material is the identifying marker of the taggant. In an embodiment, a method of making the identification system disclosed herein comprises adsorbing at least two different metal elements into an inert encapsulating material, wherein a pre-selected combination of metal elements and/or a pre-selected proportion of metal elements is the identifying marker of the taggant.

In an embodiment, a method of making the identification system disclosed herein comprises adsorbing at least two different metal elements into an inert encapsulating material, wherein a pre-selected combination of metal elements and/or a pre-selected proportion of metal elements, and a pre-selected inert encapsulating material, is the identifying marker of the taggant. In an embodiment, a method of making the identification system disclosed herein comprises adsorbing at least two different metal elements into an inert encapsulating material, wherein a pre-selected combination of metal elements and/or a pre-selected proportion of metal elements, and a pre-selected coating material, is the identifying marker of the taggant. In an embodiment, a method of making the identification system disclosed herein comprises adsorbing at least two different metal elements into an inert encapsulating material, wherein a pre-selected combination of metal elements and/or a pre-selected proportion of metal elements, a pre-selected inert encapsulating material, and a pre-selected coating material, is the identifying marker of the taggant.

As used herein, pre-selected refers to a purposeful selection of metal elements and/or their proportions and/or materials that is made in advance. The selection of the metal elements and/or their relative proportions and/or the materials is based on many factors including, but not limited to, the object to be identified, the surface of the object to be identified, the detection method, the sensitivity of the detection device, the level of desired encryption, the placement of the identification system on the object, the thickness of the identification system, the coating on the taggant if any, the coating on the object if any, and the like.

### Objects and Systems Comprising the Taggant

Disclosed herein is an object comprising an identification system as disclosed herein. The object can be anything that is capable of incorporating the identification system. An object includes, but is not limited to, currency, ballistics, an explosive, a shipment, a parcel, a pharmaceutical, food, a crop, a document, a letter, a vehicle, an animal, a label, packaging, an identification card, good in commerce, and the like.

Disclosed herein is an anticounterfeiting system comprising an identification system as disclosed herein. Disclosed herein is a message encryption system comprising an identification system as disclosed herein. Disclosed herein is an authentication system comprising an identification system as disclosed herein. Disclosed herein is an anti-piracy system comprising an identification system as disclosed herein.

### A Method of Identifying an Object

Disclosed herein is a method of identifying an object comprising the identification system disclosed herein.

In an embodiment, the method of identifying an object comprises applying an identification system as disclosed herein to an object and detecting the identifying marker of the taggant. As used herein, application of the identification system to an object refers to incorporating the identification system onto an object by any means known in the art including any means as described herein. Application can be applied to any portion of an object by any method such that the identifying marker of the taggant can be detected.

In an embodiment, the detecting comprises any method as known in the art to detect and/or identify the metal elements and/or proportion of metal elements of the taggant. In an embodiment, the detecting comprises emission of electromagnetic radiation that is characteristic of the metal elements of the taggant. In an embodiment, the detecting comprises absorbance of the electromagnetic radiation that is characteristic of the metal elements of the taggant.

In an embodiment, the detecting is non-destructive to the taggant. As used herein, non-destructive refers to a detection method that does not render the taggant unusable for its intended purpose. In an embodiment, the identifying marker of the taggant can be detected multiple times, over and over, by the same or varying detection methods.

In an embodiment, the detecting is conducted on-site. As used herein, on-site is meant to refer to a detection method wherein the identification system and/or object does not need to be sent to a specific facility for measurement and/or analysis. Non-limiting examples of on-site detection methods include a hand-held device and/or a desktop or benchtop device.

In an embodiment, detecting the identifying marker of the taggant comprises X-ray fluorescence spectroscopy (XRF). XRF is capable of identifying and measuring the elemental composition of a taggant by measuring the X-rays emitted when the sample is excited. When an atom in the sample is irradiated with X-ray radiation, an electron from one of the atom's inner orbital shells is ejected from the atom. When a remaining electron drops to the lower energy state it will release a characteristic fluorescent X-ray. Each of the elements present in a taggant produces a set of characteristic fluorescent X-ray emissions whose wavelengths are unique for that specific element.

Using XRF, the taggants described herein emit a characteristic set of wavelengths that identifies the metals present. In addition, the intensity or abundance of the emission is directly proportional to the amount of the metal present, permitting identification of the elemental composition and the relative proportion of the metals present. Additionally, XRF detection method is element specific, therefore the presence of additional substances containing other elements does not interfere in the detection of the elements of interest.

Other detection methods can be used to similarly detect and/or identify the metal elements and/or proportion of metal elements of the taggant including, but not limited to, energy dispersive x-ray analysis, particle induced x-ray emission, synchrotron radiation induced x-ray emission, atomic absorption spectroscopy, atomic emission spectroscopy, optical emission spectroscopy, mass spectrometry, inductively coupled plasma mass spectrometry, inductively coupled plasma atomic emission spectroscopy, and the like.

In an embodiment, the method comprises detecting trace levels of the metal elements of the taggant.

The present invention is further illustrated by the following examples, which should not be considered as limiting in any way.

### EXAMPLES

Reference to embodiments of the present invention are further defined in the following non-limiting Examples. It should be understood that these Examples, while indicating certain embodiments of the invention, are given by way of illustration only. From the above discussion and these Examples, one skilled in the art can ascertain the essential characteristics of this invention, and without departing from the spirit and scope thereof, can make various changes and modifications of the embodiments of the invention to adapt it to various usages and conditions. Thus, various modifications of the embodiments of the invention, in addition to those shown and described herein, will be apparent to those skilled in the art from the foregoing description. Such modifications are also intended to fall within the scope of the appended claims.

The following materials and procedures were used in the Examples.

Zeolite ZSM-5, ammonium salt, surface area 425 m²/g, 23:1 ratio SiO₂:Al₂O₃, Alfa Aesar, was used as received.

Zeolite Y, Thermoscientific, ammonium salt, 730 m²/g, 12:1 SiO₂:Al₂O₃ mole ratio.

Zeolite Ferrierite, Thermoscientific, ammonium salt, 400 m²/g, 20:1 SiO₂:Al₂O₃ mole ratio.

Chromium(III) nitrate nonahydrate, 98.5%, Alfa Aesar, was used as received.

Calcium(II) nitrate tetrahydrate, 98%, Acros Organics, was dried over anhydrous calcium sulfate prior to use.

Cobalt(II) nitrate hexahydrate, 97.7%, Alfa Aesar, was dried over anhydrous calcium sulfate prior to use.

Copper(II) nitrate hemipentahydrate, 98%, Alfa Aesar, was dried over anhydrous calcium sulfate prior to use.

Lanthanum(III) nitrate hexahydrate, 99.9%, Strem Chemical, was dried over anhydrous calcium sulfate prior to use.

Iron(III) nitrate nonahydrate, 98-101%, Alfa Aesar, was dried over anhydrous calcium sulfate prior to use.

Manganese(II) nitrate tetrahydrate, Acros Organics, was dried over anhydrous calcium sulfate prior to use.

Nickel(II) nitrate hexahydrate, 98%, Alfa Aesar, was dried over anhydrous calcium sulfate prior to use.

Strontium nitrate, reagent grade, was dried over anhydrous calcium sulfate prior to use.

Ammonium cerium(IV) nitrate, GFS Chemicals, 99.9-100.1%

Hydrochloric acid solution, 0.1 M, was prepared from concentrated hydrochloric acid solution, 36.5-38.0%, EMD, and distilled water. This solution has a pH of 1.

Ammonia solution, 0.5 M, reagent grade.

Distilled water was used in all reactions and procedures where water was a reagent.

Red acrylic paint, Liquidex Basics Acrylic, Pyrrole red, PR254, was used as received.

Blue oil paint, Master's Touch, Cerulean Blue Pigment, Fast Blue B, PB15, Titanium Oxide, R-902, PW6, was used as received.

α-D-glucose, 99%, was obtained from Acros Organics.

Acetone, Fisher Scientific, 99.7%.

Corn kernels, a sweet corn “Kandy Korn” hybrid, were obtained from Earl May. Miracle-Gro potting mix.

0.50 inch spherical lead balls were obtained from Thompson/Center Arms.

Hi-Tek supercoat powder was obtained from Hi-Performance Bullet Coatings. This material is applied to lead bullets to create a polymer coating that reduces fragmentation when the bullet hits a target

X-ray fluorescence (XRF) measurements were carried out using a hand-held Bruker Tracer 5G instrument. The GeoExploration application with the three-phase oxide calibration mode was used to measure the samples. All measurements were carried out with the small sample safety shield enclosing the sample. Zeolite or metal-zeolite taggant powder samples were loaded into a plastic sample holder on a piece of filter paper and covered with Prolene film held in place by a polyvinyl chloride ring. Three different plastic sample holders were used: a wide area sample holder with a diameter of 41 mm and a depth of 0.5 mm, a narrow area sample holder with a diameter of 23 mm and a depth of 1 mm, or a three-part XRF sample cup with a diameter of 24 mm and a depth of 19 mm. Measurements of the paint samples on filter paper were carried out using the flat low background plate as the safety shield covering the sample, and measurements of powdered samples loaded in sample holders were carried out with the cylindrical dome small sample safety shield enclosing the sample. For each sample, two XRF measurements were taken, and the sample was repositioned between measurements.

Atomic emission spectroscopy (AES) measurements were taken using a Perkin Elmer Analyst 200 instrument. The measurements were done using an acetylene/air flame. Triplicate measurements were carried out on the standards, controls, and samples.

### Example 1 Adsorption of Sr and Co into ZSM-5

Metal-zeolite samples with differing ratios of Sr and Co were prepared in amounts according to Table 1.

Mixtures of approximately 1 g of zeolite ZSM-5 and varying masses of strontium nitrate and cobalt(II) nitrate hexahydrate in 20 mL of water were stirred at 60° ° C. to 80° C. for one hour. The mixtures were then vacuum filtered, the residues were washed with about 5 mL of water and then dried over anhydrous calcium sulfate. The samples were then evaluated by XRF analysis.

TABLE 1

| | Mass | Mass | Mass | | | | | Uncertainty |
|---|---|---|---|---|---|---|---|---|
| | ZSM-5 | Sr(NO₃)₂ | Co(NO₃)₂•6 H₂O | XRF | | | Sr:Co | in Sr:Co ratio |
| Sample | (g) | (g) | (g) | measurement | Sr (%) | Co (%) | ratio | (%) |
| A | 1.0007 | 0.1009 | 0.0507 | 1 | 0.679 ± 0.004 | 0.653 ± 0.011 | 1:0.96 | 5% |
| | | | | 2 | 0.663 ± 0.004 | 0.667 ± 0.011 | 1:1.01 | |
| B | 1.0066 | 0.0100 | 0.0011 | 1 | 0.111 ± 0.002 | 0.057 ± 0.003 | 1:0.51 | 6% |
| | | | | 2 | 0.119 ± 0.002 | 0.057 ± 0.003 | 1:0.48 | |
| C | 1.0011 | 0.0507 | 0.0508 | 1 | 0.509 ± 0.004 | 0.816 ± 0.013 | 1:1.6 | 6% |
| | | | | 2 | 0.468 ± 0.004 | 0.802 ± 0.012 | 1:1.7 | |
| D | 1.0063 | 0.0509 | 0.0208 | 1 | 0.482 ± 0.003 | 0.407 ± 0.009 | 1:0.84 | 7% |
| | | | | 2 | 0.410 ± 0.003 | 0.368 ± 0.008 | 1:0.90 | |
| E | 1.0013 | 0.0503 | 0.0103 | 1 | 0.585 ± 0.004 | 0.195 ± 0.006 | 1:0.33 | 0% |
| | | | | 2 | 0.591 ± 0.004 | 0.195 ± 0.006 | 1:0.33 | |
| F | 1.0034 | 0.0503 | 0.0011 | 1 | 0.607 ± 0.004 | 0.041 ± 0.003 | 1:0.068 | 1% |
| | | | | 2 | 0.601 ± 0.004 | 0.040 ± 0.003 | 1:0.067 | |
| G | 1.0073 | 0.0102 | 0.0509 | 1 | 0.105 ± 0.002 | 0.927 ± 0.013 | 1:8.8 | 0% |
| | | | | 2 | 0.112 ± 0.002 | 0.982 ± 0.014 | 1:8.8 | |

The XRF data in Table 1 shows that it is possible to adsorb differing ratios of metal ions, specifically Sr and Co, into a zeolite. The ratio of Sr to Co adsorbed differs from the ratio of the metal ions in the reaction mixtures, with preferential adsorption of Co being observed over Sr. The duplicate XRF measurements were consistent, resulting in an uncertainty in the Sr to Co ratio of 7% or less for all measurements.

The formation of multiple Sr to Co ratios in the metal-zeolite material and the ability to clearly distinguish them within the uncertainty limits of the XRF demonstrates that it is feasible to create a large number of taggant compositions with metal ions adsorbed into zeolite. The proportions of the metal ions adsorbed into the zeolite differ from the initial proportions of the mixture. Additionally, the Sr to Co ratio is dependent on the relative amounts of metal ions compared to zeolite in the reaction mixture. Thus, the conditions necessary for the creation of specific, unique taggant compositions are not easily predicted and must be discovered for each set of multiple metal ions and each different zeolite framework used to encapsulate them.

### Example 2—Coking of Metal-Zeolite Samples

Various samples (ZSM-5/Co, ZMS-5/Sr/Co, ZMS-5/Cr/Cu/Ni/La) were formulated and coated with a layer of carbon by coking to evaluate the impact of a coating on the taggant material.

FIG. 2 shows a photograph of (a) zeolite ZSM-5, (b) zeolite ZSM-5 with Co adsorbed into it, and (c) zeolite ZSM-5 with Co adsorbed into it and coated by coking. XRF composition data for the ZSM-5/Co samples before and after coking are shown in Table 2. The XRF measurements 1 and 2 on ZSM-5/Co before coking were recorded at the same time as the coked samples A and B, measurements 3 and 4 on ZSM-5/Co before coking were recorded at the same time as coked sample C. The data show that the Co was still readily detectable after the zeolite was coated with a layer of carbon in the coking process. The percentage of the Co in the ZSM-5/Co sample was reduced after coking, because an additional component, the carbon coating, was added to the material.

TABLE 2

| | XRF | | | |
|---|---|---|---|---|
| | Measure- | | | |
| Sample | ment | SiO₂% | Al₂O₃% | Co % |
| ZSM-5/Co | 1 | 66.5 ± 0.7 | 3.5 ± 0.3 | 1.343 ± 0.016 |
| before coking* | 2 | 63.0 ± 0.7 | 3.4 ± 0.3 | 1.070 ± 0.014 |
| | 3 | 56.7 ± 0.7 | 2.8 ± 0.3 | 1.031 ± 0.014 |
| | 4 | 55.5 ± 0.7 | 2.7 ± 0.3 | 1.046 ± 0.014 |
| ZSM-5/Co after | 1 | 67.6 ± 0.8 | 3.7 ± 0.3 | 0.460 ± 0.009 |
| coking sample A | 2 | 68.4 ± 0.8 | 4.0 ± 0.3 | 0.449 ± 0.009 |
| ZSM-5/Co after | 1 | 68.8 ± 0.8 | 3.6 ± 0.3 | 0.578 ± 0.010 |
| coking sample B | 2 | 69.2 ± 0.8 | 3.9 ± 0.3 | 0.984 ± 0.014 |
| ZSM-5/Co after | 1 | 69.0 ± 0.8 | 4.0 ± 0.3 | 0.739 ± 0.012 |
| coking sample C | 2 | 73.0 ± 0.8 | 4.4 ± 0.3 | 0.962 ± 0.013 |

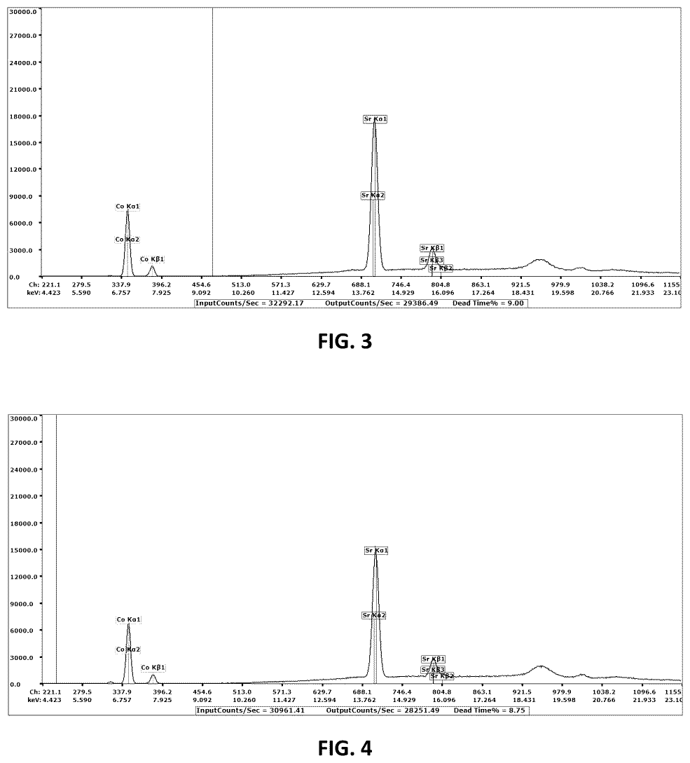

The XRF spectra for the uncoked and coked ZSM-5/Sr/Co samples are shown in FIG. 3 and FIG. 4, respectively. The XRF spectra show that the X-ray emission peaks from both Sr and Co are readily detected even after the carbon coating is applied by the coking procedure. The sample compositions for the ZSM-5/Sr/Co samples measured by XRF before and after coking are in Table 3. This data shows a small decrease in the percentage of Sr and Co in the coked sample compared to the uncoked sample, as expected when the additional component of a coating is added to the zeolite taggant material. There is not a significant difference in the Sr to Co ratio measured for the coked sample compared to the uncoked sample, and the uncertainties in the ratio were the same for the coated and uncoated samples.

TABLE 3

| | XRF | | | | | Sr:Co | Uncertainty |
|---|---|---|---|---|---|---|---|
| Sample | Measurement | SiO₂ % | Al₂O₃ % | Sr % | Co % | ratio | in Sr:Co ratio (%) |
| ZSM-5/Sr/Co | 1 | 79.3 ± 0.8 | 4.8 ± 0.4 | 0.365 ± 0.003 | 1.053 ± 0.014 | 1:2.88 | 5% |
| before coking | 2 | 79.4 ± 0.8 | 4.9 ± 0.4 | 0.343 ± 0.003 | 1.039 ± 0.014 | 1:3.03 | |
| ZSM-5/Sr/Co | 1 | 72.5 ± 0.8 | 4.3 ± 0.3 | 0.347 ± 0.003 | 0.964 ± 0.014 | 1:2.78 | 5% |
| after coking | 2 | 72.6 ± 0.8 | 4.0 ± 0.3 | 0.314 ± 0.003 | 0.914 ± 0.013 | 1:2.91 | |

The sample compositions for the ZSM-5/Cr/Cu/Ni/La samples measured by XRF before and after coking are shown in Table 4. The La was below the limits of detection in all the samples, which shows that the zeolite ZSM-5 has a strong preference for the adsorption of Cr³⁺, Cu²⁺ and Ni²⁺ cations over the La³⁺ cation. The Cr, Cu, and Ni were readily detectable in both the uncoked and the coked samples, which shows that the metal ions that are adsorbed by the zeolite can still be detected by XRF after a coating is applied to the taggant material. There was a slight decrease in the ratios of Cu and Ni relative to the Cr in the coked sample compared to the ratios in the uncoked samples. The ratios of Cu to Ni in the coked and uncoked samples were similar.

TABLE 4

| | XRF | | | | | | | Cr:Cu:Ni:La |
|---|---|---|---|---|---|---|---|---|
| Sample | Measurement | SiO₂ % | Al₂O₃ % | Cr % | Cu % | Ni % | La % | % ratio |
| ZSM-5/Cr, | 1 | 76.9 ± 0.8 | 4.8 ± 0.4 | 0.097 ± 0.010 | 0.444 ± 0.008 | 0.483 ± 0.006 | <LOD* | 1:4.6:5.0:0 |
| Cu, Ni, La | 2 | 74.8 ± 0.8 | 4.6 ± 0.4 | 0.096 ± 0.010 | 0.417 ± 0.005 | 0.454 ± 0.006 | <LOD | 1:4.3:4.7:0 |
| before coking | | | | | | | | |
| ZSM-5/Cr, | 1 | 82.6 ± 0.9 | 5.4 ± 0.4 | 0.098 ± 0.011 | 0.291 ± 0.004 | 0.322 ± 0.005 | <LOD | 1:3.0:3.3:0 |
| Cu, Ni, La | 2 | 78.9 ± 0.8 | 4.9 ± 0.4 | 0.082 ± 0.010 | 0.296 ± 0.004 | 0.299 ± 0.005 | <LOD | 1:3.6:3.6:0 |
| after coking | | | | | | | | |

*LOD = limit of detection

The results show that the metal ions adsorbed by a zeolite can still be detected by XRF with good sensitivity after the addition of a coating to the zeolite particles. The ratios of the different metal ions can still be determined after the coating is applied to the zeolite particles with the metal ions adsorbed into them. The data shows that for some combinations of metal ions adsorbed in the zeolite the application of a coating does not impact the ratios of the different metal ions measured by XRF. However, for some metal ions the application of a coating may change the ratios of the different metal ions as measured by XRF. This can be taken into account in designing the taggant compositions and most importantly, the coated samples still give consistent ratios of the different metals adsorbed in the zeolite when measured by XRF.

The capability of adding a coating to the metal-zeolite taggant material while retaining the ability to measure the proportions of different metal ions in the taggant by XRF widens the range of applications and environments in which these materials can be used. These metal-zeolite materials are already very stable in many different chemical environments and over a wide range of temperatures. The capacity to add a coating will make them compatible with an even wider range of chemical conditions. The ability to add a coating to the metal-zeolite taggants will also greatly increase the difficulty of tampering with the taggants in attempts to alter their composition and provides an additional security measure.

### Example 3—Metal Zeolite Taggant Stability in an Extreme Environment

Tagged bullets were created from polymer coated 200 grain projectiles comprising 13 grams Pb coated with a composite epoxy urethane. The projectiles were lightly coated with cyanoacrylate glue (superglue) and doped with a ZSM-5/Sr taggant or doped with just strontium nitrate as a standard. The taggant material was attached to the base of the bullets. The projectiles were then pressed into a 45acp case with 4 grains (0.26 grams) of Alliant Bullseye powder and a Winchester large pistol primer. The cartridges were then discharged into a General Chemistry textbook at 7 yards.

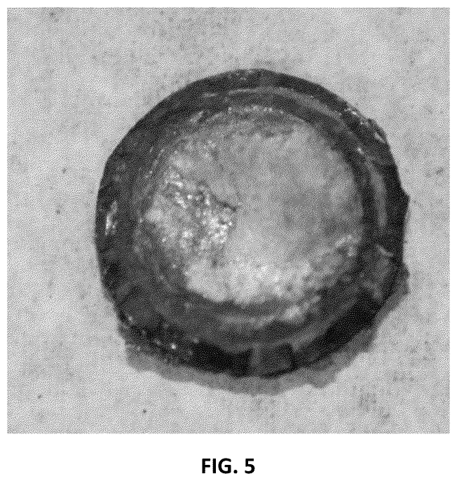

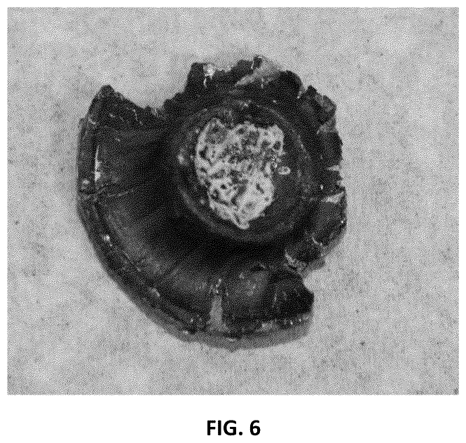

FIG. 5 shows a photograph of a lead bullet coated with a composite epoxy urethane that was tagged with strontium nitrate after it was fired and recovered. FIG. 6 shows a photograph of a lead bullet coated with a composite epoxy urethane that was tagged with ZSM-5/Sr taggant material after it was fired and recovered.

XRF measurements were made on the bullets recovered after they were fired by placing them directly on the XRF instrument and enclosing them with a small sample safety shield. The XRF data is shown in Table 5.

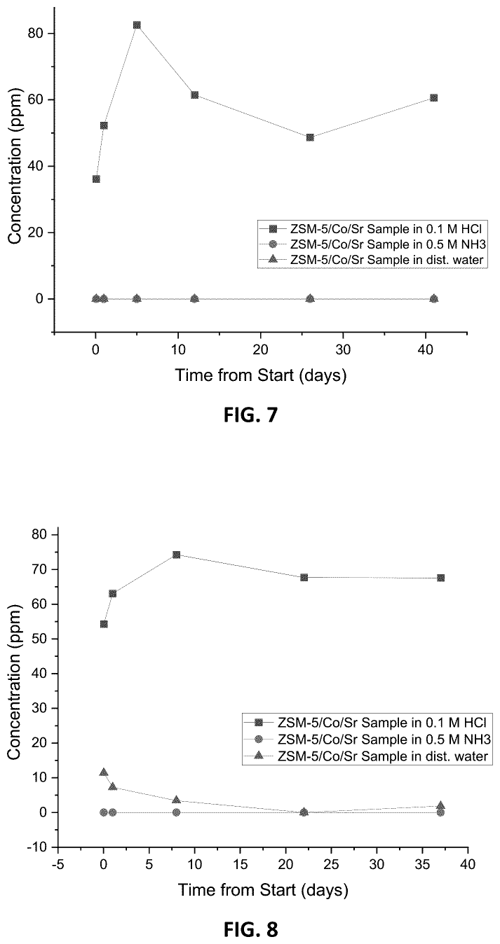

TABLE 5

| | XRF | | | | |
|---|---|---|---|---|---|
| Sample | Measurement | SiO₂% | Al₂O₃% | Sr % | Pb % |
| Bullet tagged | 1 | <LOD | <LOD | 14.47 ± 0.04 | 10.4 ± 0.1 |
| with strontium | 2 | 6.5 ± 0.4 | 1.1 ± 0.3 | 10.55 ± 0.04 | 17.7 ± 0.2 |
| nitrate | | | | | |
| (FIG. 6) | | | | | |
| Bullet tagged | 1 | 58.3 ± 0.8 | 2.6 ± 0.3 | 0.287 ± 0.005 | 24.7 ± 0.2 |
| with ZSM-5/Sr | 2 | 74.1 ± 0.9 | 4.1 ± 0.4 | 0.247 ± 0.004 | 17.9 ± 0.9 |
| (FIG. 7) | | | | | |

The bullet tagged with strontium nitrate had a large amount of strontium detected, from 10 to 14%. There was a fair bit of variability in the percentage of Sr, and of Pb, detected in this sample because the XRF instrument has an X-ray excitation beam diameter of 8 mm, which was larger than the areas the strontium nitrate was attached to, so the percentage composition varied according to the exact position of the X-ray beam used to irradiate the sample. The bullet tagged with ZSM-5/Sr showed smaller amounts of Sr than the bullet tagged with strontium nitrate, as expected. The average Sr value for the ZSM-5/Sr tagged bullet of 0.27±0.02% was more than ten times greater than the uncertainty in the Sr percentage, showing that the XRF measurement still had a very good signal-to-noise ratio and the metal-zeolite taggant was readily detected on the bullet.

The ability to detect the ZSM-5/Sr taggant on the bullet after it was fired shows that these metal-zeolite taggants are stable even in harsh environments. The metal-zeolite taggant on the bullet could be measured by XRF even after exposure to the very high temperatures and the oxidizing environment produced by the explosion of the propellant as the bullet was fired and after the high velocity impact of the tagged projectile with the target. The stability of metal zeolite taggants under extreme conditions means that they can be used in a wider range of conditions than other taggant technologies that are currently on the market.

### Example 4—Evaluation of Solution Leaching for Coated and Uncoated Samples

Metal-zeolite samples were prepared in amounts according to Table 6. Zeolite ZSM-5 and the metal salts were mixed in distilled water. The mixture was placed on a hot plate to heat the solution to approximately 60° C. and then stirred for 1 hour. The solution was left to cool while stirring and the solid metal-zeolite was separated through vacuum filtration using Whatman Type 6 filter paper and then washed with three aliquots of 10 mL of distilled water. The samples were dried in a desiccator over anhydrous calcium sulfate.

TABLE 6

| | ZSM-5 | | | Water | Temperature |
|---|---|---|---|---|---|
| | Mass | Metal Nitrate | | Volume | of Solution |
| Sample | (g) | Salt Mass (g) | | (mL) | (° C.) |
| ZSM-5/Co/Sr Sample 1 | 5.0 | Co | 0.25 | 50 | 61 |
| | | Sr | 0.50 | | |
| ZSM-5/Co/Sr Sample 2 | 4.0 | Co | 0.36 | 50 | 61 |
| | | Sr | 0.74 | | |
| ZSM-5/Ca | 8.1 | Ca | 3.0 | 100 | 57 |
| ZSM-5/Mn | 8.1 | Mn | 3.2 | 100 | 57 |
| ZSM-5/Ni/Fe/Co | 3.0 | Ni | 0.31 | 40 | 61 |
| | | Fe | 0.31 | | |
| | | Co | 0.31 | | |
| ZSM-5/Fe/Ni | 3.0 | Fe | 0.50 | 40 | 59 |
| | | Ni | 0.50 | | |
| ZSM-5/Co/Cu | 3.0 | Co | 0.50 | 40 | 59 |
| | | Cu | 0.51 | | |
| ZSM-5/Sr | 3.1 | Sr | 0.60 | — | — |

ZSM-5/Sr, ZSM-5/Ca and ZSM-5/Mn samples were coked to apply a carbon coating on the taggant particles. Solid samples of coated and uncoated metal-zeolites were suspended in either distilled water, 0.1 M hydrochloric acid, or 0.5 M ammonia solution to determine the stability of the material.

The coked samples and uncoated materials were analyzed using XRF before and after leaching studies and atomic emission spectroscopy (AES) was used to quantify the leaching of metal ions from the metal-zeolite into solution. The coked samples contained hydrophobic particles that floated on the surface of the leaching solutions. Therefore, coked samples were filtered prior to AES measurements to prevent aspiration of solid particles into the instrument which could clog the narrow tubing and spray nozzle used to introduce the solution into the flame.

FIG. 7 and FIG. 8 are graphs of the solution concentration of strontium and cobalt, respectively, desorbed from a ZSM-5/Co/Sr taggant sample in water, 0.1 M hydrochloric acid, and 0.5 M ammonia solutions. As shown in FIG. 7 and FIG. 8, a ZSM-5/Co/Sr taggant sample demonstrates little or no leaching of either strontium or cobalt metal ions from the taggant occurred in distilled water or 0.5 M ammonia, which is a basic solution. In contrast, there was substantial leaching of both metals from the taggant in 0.1 M hydrochloric acid solution.

Further leaching studies on uncoated metal-zeolite taggant samples and taggants that had been coated by coking were carried out, focusing on the behavior of uncoated samples in water or 0.1 M hydrochloric acid and coated samples in 0.1 hydrochloric acid since the ZSM-5/Co/Sr only showed significant leaching of metal ions from the uncoated taggant in 0.1 M hydrochloric acid.

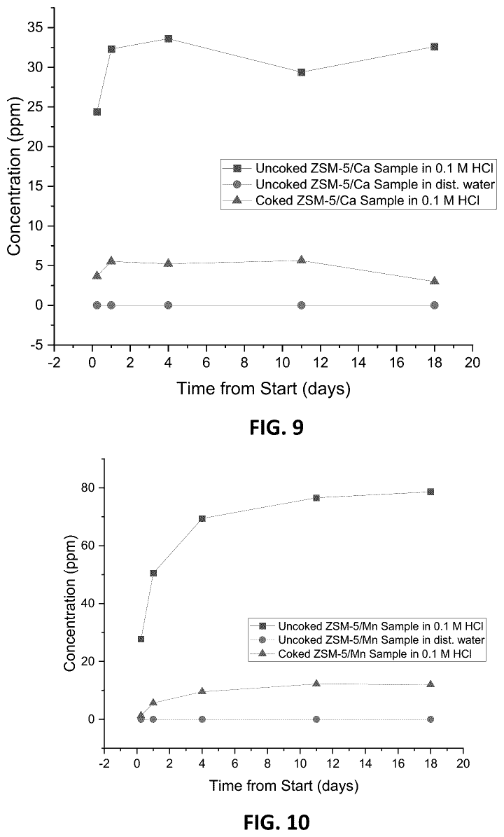

Uncoked and coked samples of ZSM-5/Ca and ZSM-5/Mn were placed in solutions of 0.1 M hydrochloric acid or water and analyzed for desorbed metal. FIG. 9 is a graph of solution concentration of calcium desorbed from the ZSM-5/Ca samples, and FIG. 10 is a graph of solution concentration of manganese desorbed from the ZSM-5/Mn samples. FIG. 9 and FIG. 10 demonstrate that the metal ions did not leach out of the uncoked taggant in distilled water. However, there was substantial leaching of the calcium and manganese cations from the uncoated taggants into 0.1 M hydrochloric acid.

This data, along with the results from the ZSM-5/Co/Sr taggant samples, show that uncoated metal-zeolite taggants can be used in solution environments that are not highly acidic without deterioration of the taggant due to leaching of the metal ions into solution. Coking the taggant particles greatly reduced the leaching of the metal cations into 0.1 M hydrochloric acid solution, demonstrating that coating the particles is effective at preventing the loss of metal ions from the taggant even under highly acidic conditions, indicating the utility of coated taggant particles in a wide range of harsh environmental conditions.

The amounts of adsorbed metal ions in the taggant samples before the samples were used in solution as measured by XRF are outlined in Tables 7 and 8.

TABLE 7

| Sample | | Strontium | Cobalt | Average | Average |
|---|---|---|---|---|---|
| Name | XRF # | % | % | Sr % | Co % |
| ZSM-5/Co/Sr | 1 | 0.5542 | 0.4668 | 0.55 | 0.47 |
| sample | 2 | 0.5509 | 0.4676 | | |

TABLE 8

| | | | | | Average |
|---|---|---|---|---|---|
| | XRF | Al₂O₃ | SiO₂ | Metal | Metal |
| Sample | Take | Percentage | Percentage | Percentage | Percentage |
| Uncoked ZSM-5/ | 1 | 3.3162 | 63.6908 | 1.2461 | 1.3 |
| Sr sample | 2 | 3.1937 | 64.7073 | 1.2921 | |
| Coked ZSM-5/ | 1 | 2.9968 | 57.8061 | 1.0476 | 1.1 |
| Sr method 1 | 2 | 2.5602 | 56.6773 | 1.0516 | |
| Coked ZSM-5/ | 1 | 4.5448 | 75.8723 | 1.0885 | 1.3 |
| Sr method 2 | 2 | 3.2510 | 63.1549 | 1.4547 | |
| Uncoked ZSM-5/ | 1 | 3.7455 | 67.8425 | 1.3073 | 1.3 |
| Ca sample | 2 | 3.9307 | 68.5113 | 1.3161 | |
| Coked ZSM-5/ | 1 | 2.6961 | 58.4477 | 1.1620 | 1.2 |
| Ca sample | 2 | 3.2432 | 60.8695 | 1.2165 | |
| Uncoked ZSM-5/ | 1 | 3.6117 | 65.2228 | 1.9942 | 2.0 |
| Mn sample | 2 | 3.5159 | 65.1146 | 2.0091 | |
| Coked ZSM-5/ | 1 | 3.0900 | 59.0383 | 1.8392 | 1.8 |
| Mn sample* | | | | | |

*The Al₂O₃ and SiO₂ percentages for the second XRF take of the coked ZSM-5/Mn sample were not measured by the instrument's automated GeoExplorer calibration method, so the results for the second take are not reported, even though the Mn percentages were similar for the two takes.

The XRF analysis of the taggants determined that the metals were still readily detectable after the metal-zeolite particles were coated with a layer of carbon in the coking process, as shown in Table 8. The percent composition of each metal in the metal-zeolite samples tended to be slightly lower after coking due to the extra component of the carbon coating.

After the AES measurements for the solution leaching experiments on coked and uncoked metal-zeolite taggant were carried out, the mixtures were filtered to collect the taggants and the recovered solid taggants were dried and analyzed by XRF. The results of the XRF measurements on the recovered solid taggant were consistent with AES measurements of the amount of metal ions leached into solution. This data is collected in Tables 9 and 10.

TABLE 9

| | | Strontium | Cobalt | Average | Average |
|---|---|---|---|---|---|
| Sample Name | XRF | % | % | Sr % | Co % |
| ZSM-5/Co/Sr in | 1 | 0.5188 | 0.3554 | 0.52 | 0.36 |
| distilled water | 2 | 0.5248 | 0.3686 | | |
| ZSM-5/Co/Sr in | 1 | 0.0575 | 0.0510 | 0.059 | 0.051 |
| 0.1M HCl | 2 | 0.0602 | 0.0504 | | |
| ZSM-5/Co/Sr in | 1 | 0.6008 | 0.5648 | 0.62 | 0.54 |
| 0.5M NH₃ | 2 | 0.6487 | 0.5234 | | |

TABLE 10

| | | | | Average |
|---|---|---|---|---|
| Sample Name | XRF | Metal % | | Metal % |
| Uncoked ZSM-5/Sr in 0.1M HCl | 1 | Sr | 0.0469 | 0.046 |
| | 2 | | 0.0447 | |
| Coked ZSM-5/Sr method 1 in | 1 | | 0.7584 | 0.76 |
| 0.1M HCl | 2 | | 0.7536 | |
| Coked ZSM-5/Sr method 2 in | 1 | | 0.4774 | 0.48 |
| 0.1M HCl | 2 | | 0.4880 | |
| Uncoked ZSM-5/Ca in 0.1M HCl | 1 | Ca | 0.4514 | 0.47 |
| | 2 | | 0.4868 | |
| Uncoked ZSM-5/Ca in distilled | 1 | | 1.3301 | 1.3 |
| water | 2 | | 1.3160 | |
| Coked ZSM-5/Ca in 0.1M HCl | 1 | | 0.9153 | 0.93 |
| | 2 | | 0.9455 | |
| Uncoked ZSM-5/Mn in 0.1M HCl | 1 | Mn | 0.3123 | 0.31 |
| | 2 | | 0.3122 | |
| Uncoked ZSM-5/Mn in distilled | 1 | | 1.0276 | 1.01 |
| water | 2 | | 0.9964 | |
| Coked ZSM-5/Mn in 0.1M HCl | 1 | | 1.3552 | 1.4 |
| | 2 | | 1.4862 | |

The uncoated ZSM-5/Co/Sr samples that were in water or 0.5 M ammonia solution showed similar levels of Co and Sr to the amounts measure before leaching, but the sample that was in 0.1 M hydrochloric acid solution was an order of magnitude lower in both Co and Sr after leaching. The XRF analysis of the ZSM-5/Sr, ZSM-5/Ca and ZSM-5/Mn samples recovered showed much higher levels of the metal remained in the coked samples than the uncoked samples after leaching in 0.1 M hydrochloric acid. This confirms that coating the taggants protects the taggant from desorption of the metal ions in highly acidic environments.

### Example 5—Metal-Zeolite Taggants Mixed with Paint

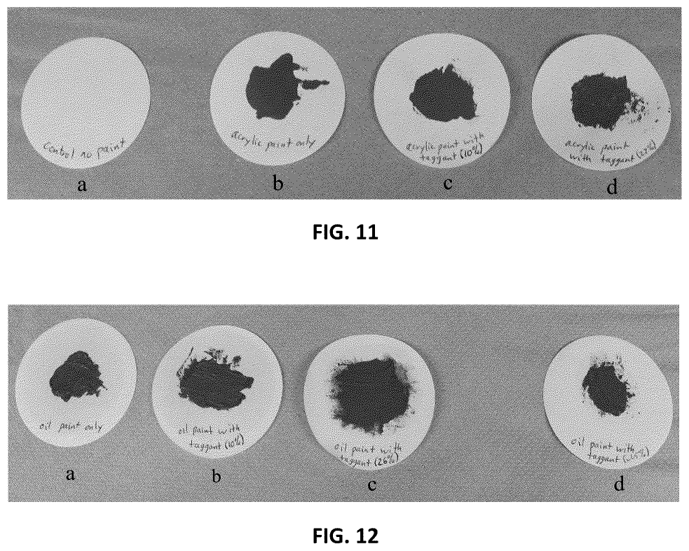

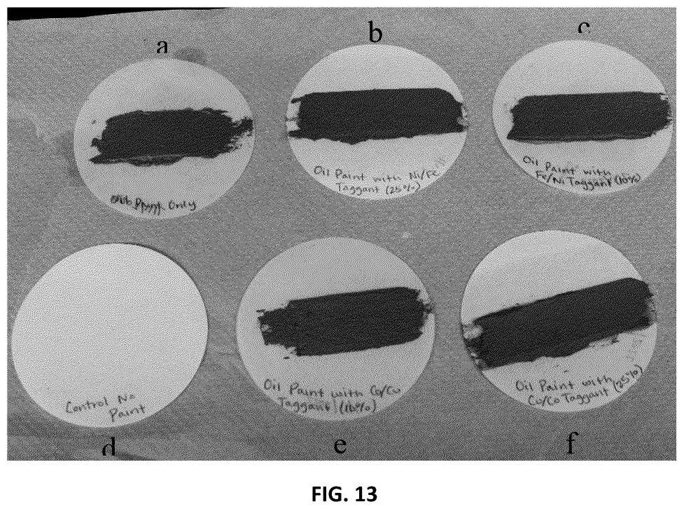

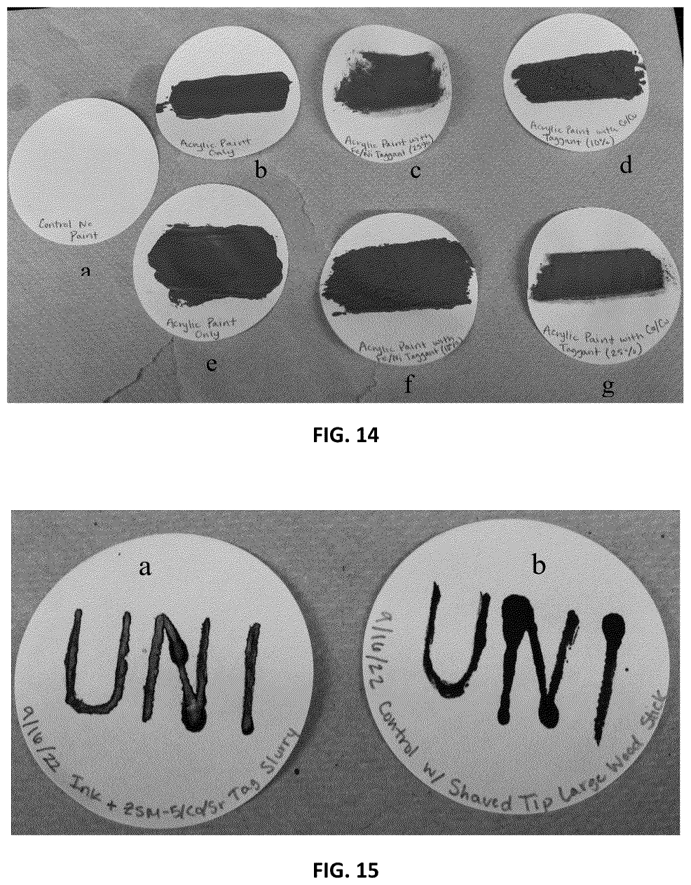

Metal-zeolite taggants were prepared according to Table 6, using the method described in Example 4. ZSM-5/Co/Sr, ZSM-5/Fe/Ni, and ZSM-5/Co/Cu samples were mixed with acrylic and oil paints as spread onto filter paper as shown in FIG. 11, FIG. 12, FIG. 13, and FIG. 14. The samples comprised either 10% taggant or 25-27% taggant. Samples of paint only, and a control sample of only filter paper were also prepared. The paint samples were spread onto filter paper without precisely determining the thickness of the paint layer produced. The paint samples with ZSM-5/Fe/Ni taggant or the ZSM-5/Co/Cu taggant were spread in a 1.0 mm thick layer, using 1.0 mm thick glass slides on either side of the strip to control the paint thickness. The paint layer for the ZSM-5/Co/Sr sample was less than 1 mm thick.

The XRF results for the paint-taggant samples are shown in Tables 11-13. Table 11 shows the XRF analysis of the Sr to Co ratio of paint samples with the ZSM-5/Co/Sr taggant. Table 12 shows the XRF analysis of the Fe to Ni ratio of paint samples with ZSM-5/Fe/Ni taggant. Table 13 shows the XRF analysis of the Co to Cu ratios of paint samples with ZSM-5/Co/Cu taggant.

TABLE 11

| | | | | | Average |
|---|---|---|---|---|---|
| | | Strontium | Cobalt | Sr:Co | Sr:Co |
| Sample Name | XRF | % | % | Ratio | Ratio |
| Acrylic Paint with 10% | 1 | 0.0983 | 0.1363 | 1:1.387 | 1:1.4 |
| ZSM-5/Co/Sr taggant | 2 | 0.0890 | 0.1255 | 1:1.410 | |
| Acrylic Paint with 27% | 1 | 0.2485 | 0.2622 | 1:1.055 | 1:1.0 |
| ZSM-5/Co/Sr taggant | 2 | 0.2888 | 0.2855 | 1:0.989 | |
| Oil Paint with 10% | 1 | 0.0659 | 0.0589 | 1:0.894 | 1:0.89 |
| ZSM-5/Co/Sr taggant | 2 | 0.0696 | 0.0620 | 1:0.891 | |
| Oil Paint with 26% | 1 | 0.2981 | 0.1691 | 1:0.567 | 1:0.55 |
| ZSM-5/Co/Sr taggant | 2 | 0.2956 | 0.1596 | 1:0.540 | |
| Oil Paint with ≈25% | 1 | 0.1039 | 0.1235 | 1:1.189 | 1:1.1 |
| ZSM-5/Co/Sr taggant | 2 | 0.1051 | 0.1152 | 1:1.096 | |

TABLE 12

| | | | | | Average |
|---|---|---|---|---|---|
| | | Iron | Nickel | Fe:Ni | Fe:Ni |
| Sample Name | XRF | % | % | Ratio | Ratio |
| Oil Paint with 10% | 1 | 0.1150 | 0.0880 | 1:0.765 | 1:0.74 |
| ZSM-5/Fe/Ni taggant | 2 | 0.1226 | 0.0880 | 1:0.718 | |
| Oil Paint with 25% | 1 | 0.2374 | 0.1861 | 1:0.784 | 1:0.78 |
| ZSM-5/Fe/Ni taggant | 2 | 0.2462 | 0.1916 | 1:0.778 | |
| Acrylic Paint with 10% | 1 | 0.2389 | 0.1949 | 1:0.816 | 1:0.84 |
| ZSM-5/Fe/Ni taggant | 2 | 0.2307 | 0.1992 | 1:0.863 | |
| Acrylic Paint with 25% | 1 | 0.4243 | 0.4124 | 1:0.972 | 1:0.97 |
| ZSM-5/Fe/Ni taggant | 2 | 0.4662 | 0.4542 | 1:0.974 | |

TABLE 13

| | | | | | Average |
|---|---|---|---|---|---|
| | | Cobalt | Copper | Co:Cu | Co:Cu |
| Sample Name | XRF | % | % | Ratio | Ratio |
| Oil Paint with 10% | 1 | 0.1071 | 0.2278 | 1:2.127 | 1:2.2 |
| ZSM-5/Co/Cu taggant | 2 | 0.1158 | 0.2743 | 1:2.369 | |
| Oil Paint with 25% | 1 | 0.2621 | 0.3392 | 1:1.294 | 1:1.3 |
| ZSM-5/Co/Cu taggant | 2 | 0.2627 | 0.3379 | 1:1.286 | |
| Acrylic Paint with 10% | 1 | 0.2588 | 0.1691 | 1:0.653 | 1:0.63 |
| ZSM-5/Co/Cu taggant | 2 | 0.2615 | 0.1568 | 1:0.600 | |
| Acrylic Paint with 25% | 1 | 0.6303 | 0.3706 | 1:0.588 | 1:0.60 |
| ZSM-5/Co/Cu taggant | 2 | 0.5996 | 0.3684 | 1:0.614 | |

As expected, larger amounts of the metal ions adsorbed into the zeolite were measured for the paint samples that contained 25-27% of taggant compared to the paint samples that contained 10% of taggant. Though the metal concentrations measured were lower in the 10% taggant samples, the taggant was still readily detected, demonstrating that high concentrations of taggant are not needed. The ability to consistently detect the taggant by XRF at modest concentrations in paint is significant, because paint is a complex matrix, containing considerable amounts of other inorganic solids as opacifiers and pigments that could also adsorb or scatter X-rays and reduce the signal intensity.

The paint-taggant samples with ZSM-5/Co/Sr and ZSM-5/Co/Cu taggants showed that there was substantial variability in the measured ratio of the adsorbed metal cations in samples with differing paint-taggant proportions and between the taggants in the acrylic paint and oil paint matrices. The metal ratios varied by a factor of 2-3 across all the paint-taggant mixtures.

The XRF measurements of the paint-taggant mixtures in Tables 11-13 show that the different metal ions could readily be detected when the taggant was incorporated into paints, but there was more variability in the measured ratio of the metals in the taggant than expected. One factor that may contribute to the variability in the paint-taggant sample metal ratios is the variation in the thickness of the samples and the substantial changes in the amount of material that interacts with the incident X-ray beam and the fluorescent X-rays as the proportion of taggant in the paint mixture and the type of paint used varied. Therefore, the effect of sample thickness on the measured ratios of the metals adsorbed in the metal-zeolite taggants was evaluated.

### Example 6—Analysis of Sample Thickness Dependence of Measured Metal Ratios

ZSM-5/Co/Sr, ZSM-5/Fe/Ni, ZSM-5/Co/Cu, and ZSM-5/Fe/Co/Ni samples were prepared according to Table 6, using the method described in Example 4. The ZSM-5/Co/Sr taggant was split into five separate portions and XRF measurements were conducted separately on each portion. The XRF measurements are detailed in Table 14.

TABLE 14

| | | | | | Average |
|---|---|---|---|---|---|
| | | Strontium | Cobalt | Sr:Co | Sr:Co |
| Sample Name | XRF | % | % | Ratio | Ratio |
| ZSM-5/Co/Sr | 1 | 0.5527 | 0.4337 | 1:0.785 | 1:0.81 |
| taggant Portion 1 | 2 | 0.5256 | 0.4377 | 1:0.833 | |
| ZSM-5/Co/Sr | 1 | 0.5334 | 0.4288 | 1:0.804 | 1:0.79 |
| taggant Portion 2 | 2 | 0.5622 | 0.4299 | 1:0.765 | |
| ZSM-5/Co/Sr | 1 | 0.5835 | 0.4605 | 1:0.789 | 1:0.80 |
| taggant Portion 3 | 2 | 0.5513 | 0.4499 | 1:0.816 | |
| ZSM-5/Co/Sr | 1 | 0.4615 | 0.3665 | 1:0.794 | 1:0.76 |
| taggant Portion 4 | 2 | 0.4964 | 0.3596 | 1:0.724 | |
| ZSM-5/Co/Sr | 1 | 0.4979 | 0.4063 | 1:0.816 | 1:0.79 |
| taggant Portion 5 | 2 | 0.5431 | 0.4108 | 1:0.756 | |

The results in Table 14 show a consistent Sr to Co ratio of about 1:0.8 for each portion. This demonstrates that the variability of the measured Sr to Co ratio in the different paint-taggant samples in Example 5 was not due to heterogeneity in the taggant used to make the paint-taggant mixtures.

The ZSM-5/Co/Sr taggant was loaded into a narrow sample holder in specific amounts to determine the effect of the sample thickness on the XRF results. The sample size and the XRF results are shown in Table 15.

TABLE 15

| | | | | | Average |
|---|---|---|---|---|---|
| | | Strontium | Cobalt | Sr:Co | Sr:Co |
| Sample Name | XRF | % | % | Ratio | Ratios |
| ZSM-5/Co/Sr taggant | 1 | 0.3287 | 0.3382 | 1:1.029 | 1:0.97 |
| Portion 1 (0.15 g) | 2 | 0.3658 | 0.3294 | 1:0.900 | |
| ZSM-5/Co/Sr taggant | 1 | 0.5273 | 0.4241 | 1:0.804 | 1:0.80 |
| Portion 2 (0.21 g) | 2 | 0.5228 | 0.4105 | 1:0.785 | |
| ZSM-5/Co/Sr taggant | 1 | 0.5542 | 0.4668 | 1:0.842 | 1:0.85 |
| Portion 3 (0.25 g) | 2 | 0.5509 | 0.4676 | 1:0.849 | |
| ZSM-5/Co/Sr taggant | 1 | 0.5462 | 0.4522 | 1:0.828 | 1:0.87 |
| Portion 4 Trial 1 | 2 | 0.5753 | 0.5233 | 1:0.910 | |
| (0.31 g) | | | | | |
| ZSM-5/Co/Sr taggant | 1 | 0.5232 | 0.3363 | 1:0.643 | 1:0.69 |
| Portion 4 Trial 2 | 2 | 0.459 | 0.3332 | 1:0.726 | |
| (0.31 g) | | | | | |

As the mass of the taggant sample increased, the sample thickness increased, and the measured ratio of Sr compared to Co increased slightly in terms of the general trend of the measurements with increased sample thickness. The magnitude of this trend was only a little greater than the magnitude of uncertainty in the individual XRF takes. Strontium is a heavier element than cobalt, so it absorbs shorter wavelengths of X-rays, and the fluorescent X-rays it emits are at shorter wavelengths than those emitted by cobalt. The shorter the wavelength an X-ray is, the greater its energy and the deeper into a sample it can penetrate. This means that as the sample thickness increases, the raw signal from lighter elements will tend to decrease compared to the raw signal from the heavier elements, resulting in significant differences in the measured ratios if the change in sample thickness is large enough.

The ZSM-5/Fe/Ni taggant was loaded into a narrow sample holder in specific amounts and a wide area sample holder to determine the effect of the sample thickness on the XRF results. The sample sizes and the XRF results are shown in Tables 16 and 17. Table 16 shows the XRF analysis of different amounts of ZSM-5/Fe/Ni using the narrow area sample holder, and Table 17 shows the XRF analysis of different amounts of ZSM-5/Fe/Ni using the wide area sample holder.

TABLE 16

| | | | | | Average |
|---|---|---|---|---|---|
| | | Iron | Nickel | Fe:Ni | Fe:Ni |
| Sample | XRF | % | % | Ratio | Ratio |
| ZSM-5/Fe/Ni taggant | 1 | 0.6428 | 0.5261 | 1:0.818 | 1:0.93 |
| Portion 1 (0.15 g) | 2 | 0.5359 | 0.5618 | 1:1.048 | |
| ZSM-5/Fe/Ni taggant | 1 | 0.6150 | 0.6123 | 1:0.996 | 1:1.0 |
| Portion 2 (0.20 g) | 2 | 0.6035 | 0.6248 | 1:1.036 | |
| ZSM-5/Fe/Ni taggant | 1 | 0.6092 | 0.6309 | 1:1.036 | 1:1.0 |
| Portion 3 (0.25 g) | 2 | 0.6696 | 0.7043 | 1:1.052 | |
| ZSM-5/Fe/Ni taggant | 1 | 0.6407 | 0.7124 | 1:1.112 | 1:1.1 |
| Portion 4 (0.30 g) | 2 | 0.6970 | 0.7756 | 1:1.113 | |
| ZSM-5/Fe/Ni taggant | 1 | 0.7274 | 0.7347 | 1:1.010 | 1:1.0 |
| Portion 5 (0.35 g) | 2 | 0.7281 | 0.7871 | 1:1.081 | |

TABLE 17

| | | | | | Average |
|---|---|---|---|---|---|
| | | Iron | Nickel | Fe:Ni | Fe:Ni |
| Sample | XRF | % | % | Ratio | Ratio |
| ZSM-5/Fe/Ni taggant | 1 | 0.5319 | 0.3572 | 1:0.672 | 1:0.67 |
| Portion 6 (0.30 g) | 2 | 0.5077 | 0.3422 | 1:0.674 | |
| ZSM-5/Fe/Ni taggant | 1 | 0.7574 | 0.4242 | 1:0.560 | 1:0.55 |
| Portion 7 (0.40 g) | 2 | 0.7856 | 0.4303 | 1:0.548 | |
| ZSM-5/Fe/Ni taggant | 1 | 0.7735 | 0.5222 | 1:0.675 | 1:0.66 |
| Portion 8 (0.51 g) | 2 | 0.7851 | 0.5028 | 1:0.640 | |
| ZSM-5/Fe/Ni taggant | 1 | 0.7349 | 0.4721 | 1:0.642 | 1:0.65 |
| Portion 9 (0.60 g) | 2 | 0.7865 | 0.5230 | 1:0.665 | |

The Fe to Ni ratio measured by XRF for different masses of the ZSM-5/Fc/Ni taggant in the narrow area sample holder and the wide area sample holder did not show significant differences as the thickness of the taggant in the sample holder changed for each holder by itself. However, there were significant differences in the Fe to Ni ratio for the measurements using narrow area sample holder compared to the wide area sample holder. This shows that the ZSM-5/Fe/Ni taggant has less sample depth dependence on the metal ratio determined by XRF than the ZSM-5/Co/Sr sample, but there is still some depth dependence. The lesser sample depth dependence of the XRF measurements for the ZSM-5/Fe/Ni taggant may be due to Fe and Ni being closer together on the periodic table than Co and Sr, so there is less of a difference in the energy of the X-rays absorbed and emitted by Fe and Ni. Therefore, by choosing appropriate combinations of metal ions to incorporate into the taggant the potential uncertainty in the XRF measurement of the metal ion ratio caused by different sample thicknesses can be considerably reduced.

The ZSM-5/Co/Cu taggant was loaded into a narrow sample holder in specific amounts and a wide area sample holder in specific amounts to determine the effect of the sample thickness on the XRF results. The sample sizes and the XRF results are shown in Tables 18 and 19. Table 18 shows the XRF analysis of different amounts of ZSM-5/Co/Cu using the narrow area sample holder, and Table 19 shows the XRF analysis of different amounts of ZSM-5/Co/Cu using the wide area sample holder.

TABLE 18

| | | | | | Average |
|---|---|---|---|---|---|
| | | Cobalt | Copper | Co:Cu | Co:Cu |
| Sample | XRF | % | % | Ratio | Ratio |
| ZSM-5/Co/Cu taggant | 1 | 0.5576 | 0.2625 | 1:0.471 | 1:0.50 |
| Portion 1 (0.15 g) | 2 | 0.6241 | 0.3324 | 1:0.533 | |
| ZSM-5/Co/Cu taggant | 1 | 0.9495 | 0.4800 | 1:0.506 | 1:0.48 |
| Portion 2 (0.20 g) | 2 | 0.8338 | 0.3840 | 1:0.461 | |
| ZSM-5/Co/Cu taggant | 1 | 0.9160 | 0.4243 | 1:0.463 | 1:0.46 |
| Portion 3 (0.25 g) | 2 | 0.9469 | 0.4345 | 1:0.459 | |
| ZSM-5/Co/Cu taggant | 1 | 0.9543 | 0.4806 | 1:0.504 | 1:0.50 |
| Portion 4 (0.30 g) | 2 | 0.9637 | 0.4767 | 1:0.495 | |
| ZSM-5/Co/Cu taggant | 1 | 0.9479 | 0.5149 | 1:0.543 | 1:0.53 |
| Portion 5 (0.35 g) | 2 | 0.9437 | 0.4833 | 1:0.512 | |

TABLE 19

| | | | | | Average |
|---|---|---|---|---|---|
| | | Cobalt | Copper | Co:Cu | Co:Cu |
| Sample | XRF | % | % | Ratio | Ratio |
| ZSM-5/Co/Cu taggant | 1 | 0.5576 | 0.2625 | 1:0.471 | 1:0.50 |
| Portion 1 (0.15 g) | 2 | 0.6241 | 0.3324 | 1:0.533 | |
| ZSM-5/Co/Cu taggant | 1 | 0.9495 | 0.4800 | 1:0.506 | 1:0.48 |
| Portion 2 (0.20 g) | 2 | 0.8338 | 0.3840 | 1:0.461 | |
| ZSM-5/Co/Cu taggant | 1 | 0.9160 | 0.4243 | 1:0.463 | 1:0.46 |
| Portion 3 (0.25 g) | 2 | 0.9469 | 0.4345 | 1:0.459 | |
| ZSM-5/Co/Cu taggant | 1 | 0.9543 | 0.4806 | 1:0.504 | 1:0.50 |
| Portion 4 (0.30 g) | 2 | 0.9637 | 0.4767 | 1:0.495 | |
| ZSM-5/Co/Cu taggant | 1 | 0.9479 | 0.5149 | 1:0.543 | 1:0.53 |
| Portion 5 (0.35 g) | 2 | 0.9437 | 0.4833 | 1:0.512 | |

The ZSM-5/Co/Cu taggant sample did not show any significant changes in the Co to Cu ratio measured by XRF as the thickness of the sample changed for the measurements in the narrow area sample holder as shown in Table 18. The ZSM-5/Co/Cu taggant sample in the wide area sample holder showed a slight decrease in the proportion of Co to Cu measured by XRF as the sample thickness increased as shown in Table 19. The measurement of a slightly higher proportion of the heavier element in the thicker sample was similar to the trend seen for the ZSM-5/Co/Sr taggant.

The ZSM-5/Fe/Co/Ni taggant was loaded into a narrow sample holder in specific amounts and a wide area sample holder in specific amounts to determine the effect of the sample thickness on the XRF results. The sample sizes and the XRF results are shown in Tables 20 and 21. Table 20 shows the XRF analysis of different amounts of ZSM-5/Fe/Co/Ni using the narrow area sample holder, and Table 21 shows the XRF analysis of different amounts of ZSM-5/Fe/Co/Ni using the wide area sample holder.

TABLE 20

| | | Iron | Cobalt | Nickel | Fe:Co:Ni |
|---|---|---|---|---|---|
| Sample | XRF | % | % | % | Ratio |
| ZSM-5/Fe/Ni/Co | 1 | 0.5910 | 0.6840 | 0.2350 | 1:1.2:0.40 |
| taggant Portion 1 | 2 | 0.6080 | 0.6951 | 0.2381 | 1:1.1:0.39 |
| (0.15 g) | | | | | |
| ZSM-5/Fe/Ni/Co | 1 | 0.6467 | 0.7567 | 0.2821 | 1:1.2:0.44 |
| taggant Portion 2 | 2 | 0.6426 | 0.7369 | 0.2437 | 1:1.2:0.38 |
| (0.20 g) | | | | | |
| ZSM-5/Fe/Ni/Co | 1 | 0.7078 | 0.8128 | 0.2740 | 1:1.2:0.39 |
| taggant Portion 3 | 2 | 0.6897 | 0.7931 | 0.2655 | 1:1.2:0.39 |
| (0.25 g) | | | | | |
| ZSM-5/Fe/Ni/Co | 1 | 0.5808 | 0.6887 | 0.2797 | 1:1.2:0.48 |
| taggant Portion 4 | 2 | 0.6292 | 0.7453 | 0.3337 | 1:1.2:0.53 |
| (0.30 g) | | | | | |
| ZSM-5/Fe/Ni/Co | 1 | 0.6873 | 0.8068 | 0.3144 | 1:1.2:0.46 |
| taggant Portion 5 | 2 | 0.6945 | 0.8156 | 0.3521 | 1:1.2:0.51 |
| (0.35 g) | | | | | |

TABLE 21

| | | Iron | Cobalt | Nickel | Fe:Co:Ni |
|---|---|---|---|---|---|
| Sample | XRF | % | % | % | Ratio |
| ZSM-5/Fe/Ni/Co | 1 | 0.6677 | 0.7219 | 0.1492 | 1:1.1:0.22 |
| taggant Portion 6 | 2 | 0.6551 | 0.7024 | 0.1479 | 1:1.1:0.23 |
| (0.30 g) | | | | | |
| ZSM-5/Fe/Ni/Co | 1 | 0.6874 | 0.7383 | 0.1663 | 1:1.1:0.24 |
| taggant Portion 7 | 2 | 0.6321 | 0.6949 | 0.1494 | 1:1.1:0.24 |
| (0.41 g) | | | | | |
| ZSM-5/Fe/Ni/Co | 1 | 0.5843 | 0.6490 | 0.2246 | 1:1.1:0.38 |
| taggant Portion 8 | 2 | 0.5951 | 0.6644 | 0.2233 | 1:1.1:0.38 |
| (0.50 g) | | | | | |
| ZSM-5/Fe/Ni/Co | 1 | 0.7539 | 0.8540 | 0.2248 | 1:1.1:0.30 |
| taggant Portion 9 | 2 | 0.8062 | 0.9102 | 0.2418 | 1:1.1:0.30 |
| (0.60 g) | | | | | |

As shown in Tables 20 and 21, there were no significant changes in the measured ratio of Fe compared to Co as the sample thickness increased, but the general trend in the proportion of Ni, the heaviest of the three elements was that it increased slightly compared to the Fe and Co as the sample thickness increased.

XRF measurements were also carried out on the ZSM-5/Fe/Ni, ZSM-5/Co/Cu, and ZSM-5/Co/Sr taggants using sample holder cups available from Bruker. The sample sizes and the XRF results are shown in Table 22.

TABLE 22

| | | | | | | Metal | Average |
|---|---|---|---|---|---|---|---|
| | | | | | | 1:Metal | Metal |
| Sample | XRF | Metal 1% | | Metal 2% | | 2 Ratio | Ratio |
| ZSM-5/Fe/Ni | 1 | Fe | 0.7525 | Ni | 1.7652 | 1:2.346 | 1:2.3 |
| taggant 1* | 2 | | 0.7586 | | 1.6698 | 1:2.201 | |
| ZSM-5/Fe/Ni | 1 | Fe | 0.7823 | Ni | 1.7753 | 1:2.269 | 1:2.2 |
| taggant 2* | 2 | | 0.7676 | | 1.6989 | 1:2.213 | |
| ZSM-5/Co/Cu | 1 | Co | 1.1919 | Cu | 1.1895 | 1:0.998 | 1:0.97 |
| taggant | 2 | | 1.2022 | | 1.1386 | 1:0.947 | |
| ZSM-5/Co/Sr | 1 | Sr | 0.8187 | Co | 0.6059 | 1:0.740 | 1:0.75 |
| taggant | 2 | | 0.8095 | | 0.6075 | 1:0.750 | |

*Two separate ZSM-5/Fe/Ni taggant samples were scanned (4 takes total) as it was observed that the prolene film used to cover the sample in the XRF sample cup was broken after the second take of the ZSM-5/Fe/Ni taggant sample 1.

*Two separate ZSM-5/Fe/Ni taggant samples were scanned (4 takes total) as it was observed that the prolene film used to cover the sample in the XRF sample cup was broken after the second take of the ZSM-5/Fe/Ni taggant sample 1.

These sample holders were too deep to be completely filled by the amounts of taggant available, but the sample depth in these cups was several millimeters, considerably deeper than the previously used sample holders. The XRF measurements of these much thicker samples showed a higher ratio of the heavier metal to the lighter metal compared to the XRF measurements of the much thinner samples in the wide and narrow sample holders.

Though the measured metal ratios of the taggants may vary when the sample thickness changes substantially, that will not affect the use of these materials as taggants in most applications. In the vast majority of applications, the taggants will be applied as a thin surface coating or incorporated at low levels in a material, and therefore will be too thin for the thickness dependence to significantly affect the XRF measurements. This means that the thickness dependence of the XRF measurement does not significantly limit the utility of metal-zeolites as taggants.

In applications where the material tagged can be used in thick layers, such as paints, it may be necessary to use the number of metals and the identities of the metals incorporated into the zeolite as the unique identifier for the taggant instead of the ratios of the metals. Though this reduces the number of unique identifiers that can be generated, the numbers of taggants possible are still vast. For example, with a selection of just 15 different metals as options, using three metals in a taggant gives over 2,000 possible combinations, using four metals in a taggant gives over 30,000 combinations, and using five metals gives over 350.000 combinations. Even more combinations are possible with the use of additional metals or using taggants containing higher numbers of metals.

### Example 7—Metal Zeolite Taggants in Ink

To prepare samples with taggant in ink, 0.502 g of a liquid black refillable pen ink (Pelikan 4001) was mixed with 0.205 g ZSM-5/Co/Sr taggant and used to write on filter paper. FIG. 15 shows a photograph of the writing samples. Sample (a) on the left was made with a mixture of black pen ink and a ZSM-5/Co/Sr taggant, and sample (b) on the right is a control sample with black pen ink only.

For each sample, a total of four XRF measurements were made. Two different regions of the writing were measured twice each. The sample was rotated and repositioned after the first measurement for a second XRF measurement of each region.

The percent composition of the chemical species and elements that were detected by XRF in the different samples is shown in Table 23. As shown in Table 23, there was no Co or Sr detected in the control sample. In contrast, the elements Co and Sr were clearly detected in the ink-ZSM-5/Co/Sr taggant writing sample. The ink-ZSM-5/Co/Sr sample also showed substantial amounts of Al₂O₃ and SiO₂, indicating strong signals from the zeolite framework along with the Co and Sr metal ions encapsulated within it. The percentages of Co, Sr, Al₂O₃ and SiO₂ vary a bit between measurements, due to the different amounts of the writing within the region irradiated with X-rays for each measurement. Location 1 for the sample with the ZSM-5/Co/Sr taggant was the top left corner of the ‘N’ in FIG. 15, and Location 2 was the top of ‘I’.

TABLE 23

| | | Percentage composition | | | |
|---|---|---|---|---|---|
| | | | | Ink with | Ink with |
| Element/ | | | | ZSM-5/Co/Sr | ZSM-5/Co/Sr |
| Compound | XRF | Ink only | Ink only | taggant | taggant |
| Identity | measurement | Location 1 | Location 2 | Location 1 | Location 2 |
| Al₂O₃ | 1 | — | — | 1.4 | 1.3 |
| | 2 | — | — | 1.9 | 1.5 |
| SiO₂ | 1 | 0.11 | 0.08 | 35.6 | 35.2 |
| | 2 | 0.10 | 0.08 | 45.5 | 38.6 |
| Co | 1 | — | — | 0.051 | 0.053 |
| | 2 | — | — | 0.068 | 0.059 |
| Sr | 1 | — | — | 0.028 | 0.027 |
| | 2 | — | — | 0.034 | 0.032 |

The ratios of Co to Sr measured by XRF for the two different regions of the ink-ZSM-5/Co/Sr taggant sample showed very good agreement with each other as outlined in Table 24. There was an average Sr:Co ratio of 1:1.9 at both locations.

TABLE 24

| | XRF | Strontium | Cobalt | Sr:Co | Average |
|---|---|---|---|---|---|
| Sample | measurement | (%) | (%) | Ratio | Sr:Co Ratio |
| Ink with ZSM- | 1 | 0.028 | 0.051 | 1:1.8 | 1:1.9 |
| 5/Co/Sr writing | 2 | 0.034 | 0.068 | 1:2.0 | |
| Location 1 | | | | | |
| Ink with ZSM- | 1 | 0.027 | 0.053 | 1:2.0 | 1:1.9 |
| 5/Co/Sr writing | 2 | 0.032 | 0.059 | 1:1.8 | |
| Location 2 | | | | | |

### Example 8—Metal Zeolite Taggants in Photocopier Toner

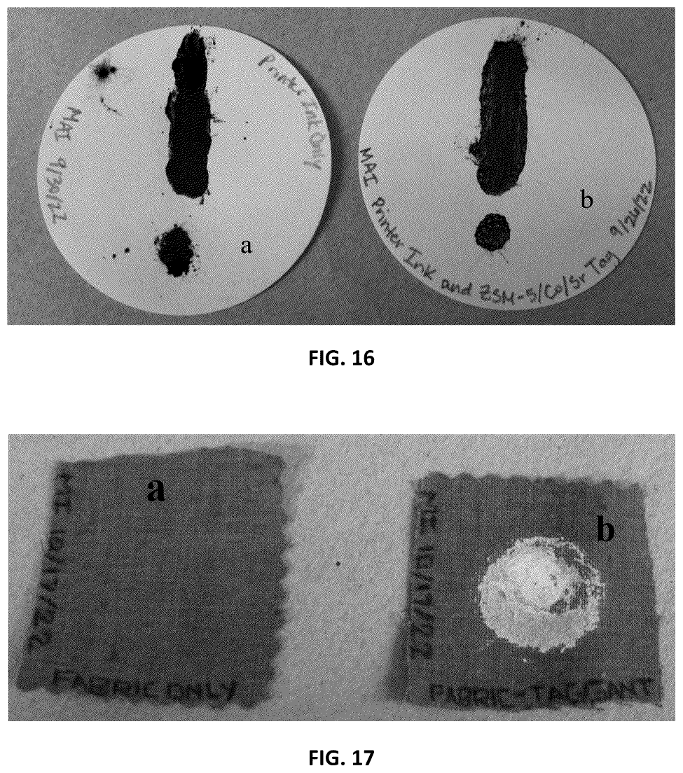

To prepare samples with taggant in toner, 0.1119 g of a black photocopier toner powder (Ricoh toner 6110D/6075/6110D, composition: wax and carbon black) was mixed with 0.0378 g ZSM-5/Co/Sr taggant and used to write on filter paper. The filter papers were gently heated on a hotplate to affix the toner to the paper. FIG. 16 shows a photograph of the writing samples. Sample (a) on the left is a control sample with toner only, and sample (b) was made with a mixture of black toner and a ZSM-5/Co/Sr taggant.

For each sample, a total of four XRF measurements were made. Two different regions of the writing were measured twice each. The sample was rotated and repositioned after the first measurement for a second XRF measurement of each region.

The percent composition of the chemical species and elements that were detected by XRF in the different samples is shown in Table 25. As shown in Table 25, there was no Co or Sr detected in the control sample. In contrast, the elements Co and Sr were detected in the toner-ZSM-5/Co/Sr taggant writing sample. The toner-ZSM-5/Co/Sr sample also showed substantial amounts of Al₂O₃ and SiO₂, indicating strong signals from the zeolite framework along with the Co and Sr metal ions encapsulated within it. The percentages of Co, Sr, Al₂O₃ and SiO₂ vary a bit between measurements, due to the different amounts of the writing within the region irradiated with X-rays for each measurement. Location 1 for the sample with the ZSM-5/Co/Sr taggant was the middle of the exclamation point in FIG. 16, and Location 2 was the dot of the exclamation point.

TABLE 25

| | | Percentage composition | | | |
|---|---|---|---|---|---|
| | | | | Toner with | Toner with |
| Element/ | | | | ZSM-5/Co/Sr | ZSM-5/Co/Sr |
| Compound | XRF | Toner only | Toner only | taggant | taggant |
| Identity | measurement | Location 1 | Location 2 | Location 1 | Location 2 |
| Al₂O₃ | 1 | — | — | 0.9 | 0.4 |
| | 2 | — | — | 0.9 | 0.3 |
| SiO₂ | 1 | 2.6 | 2.1 | 34.7 | 27.6 |
| | 2 | 2.3 | 2.0 | 35.0 | 25.4 |
| Co | 1 | — | — | 0.037 | 0.075 |
| | 2 | — | — | 0.035 | 0.070 |
| Sr | 1 | — | — | 0.018 | 0.045 |
| | 2 | — | — | 0.018 | 0.043 |

The ratios of Co to Sr measured by XRF for the two different regions of the toner-ZSM-5/Co/Sr taggant sample showed good agreement with each other as outlined in Table 26. There was an average Sr:Co ratio of 1:1.6 and 1:2.0 at the two locations of the sample measured, giving an overall average Sr:Co ratio of 1:1.8. The same batch of ZSM-5/Co/Sr taggant was used for both the ink/taggant writing sample of Example 7 and the toner/taggant image sample of Example 8, and the Sr:Co ratios of 1:1.9 and 1:1.8 for the two materials closely align.

TABLE 26

| | XRF | | | | Average |
|---|---|---|---|---|---|
| | Measure- | Strontium | Cobalt | Sr:Co | Sr:Co |
| Sample | ment | (%) | (%) | Ratio | Ratio |
| Black toner with | 1 | 0.018 | 0.037 | 1:2.1 | 1:2.0 |
| ZSM-5/Co/Sr | 2 | 0.018 | 0.035 | 1:1.9 | |
| taggant Location 1 | | | | | |
| Black toner with | 1 | 0.045 | 0.075 | 1:1.7 | 1:1.6 |
| ZSM-5/Co/Sr | 2 | 0.043 | 0.070 | 1:1.6 | |
| taggant Location 2 | | | | | |

### Example 9—Metal Zeolite Taggants on Fabric

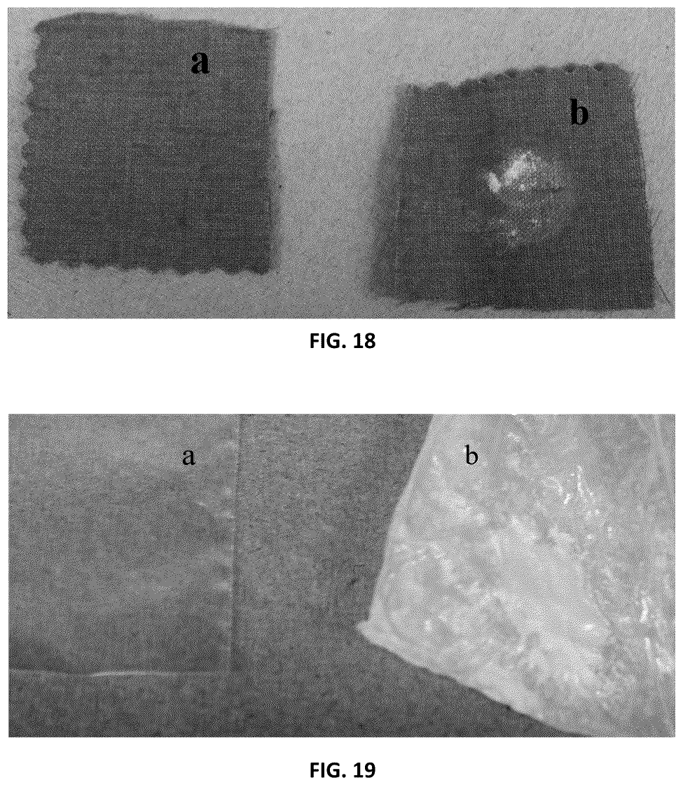

To prepare samples with taggant in on fabric, a slurry of ZSM-5/Co/Sr taggant in water was spread on a swatch of red cotton fabric and then analyzed by XRF. FIG. 17 shows a photograph of the fabric samples. Sample (a) on the left is a control sample with red cotton fabric only, and sample (b) is red cotton fabric after a slurry is applied. FIG. 18 shows the reverse sides of the swatches in FIG. 17.

For each sample, a total of four XRF measurements were made. Two different regions of the fabric swatch were measured twice each. The sample was rotated and repositioned after the first measurement for a second XRF measurement of each region. Measurements were made of both the front side of the fabric and the back side of the fabric.

The percent composition of the chemical species and elements that were detected by XRF in the different samples is shown in Table 27. As shown in Table 27, there was no Co or Sr detected in the control sample, while Sr and Co were detected on the fabric sample with the taggant. As outlined in Table 28, the elements Sr and Co were detected in the data with an average Sr:Co ratio of 1:2.2 when the front side of the swatch, the side where the taggant was added on to the fabric, was facing the XRF instrument. The Sr and Co were also detected when the reverse side of the swatch, the side opposite to where the taggant was applied, was facing the XRF instrument. However, the Sr:Co ratio was, 1:1.3, detecting a smaller proportion of Co when measured from the reverse side. The difference in the Sr:Co ratio between the front and the reverse of the taggant-labeled fabric swatch is likely due to Sr and Co having different absorption cross sections for different energy X-rays and emitting different energy X-rays when they fluoresce. X-rays with different energies are scattered and absorbed to different extents by the cotton fabric the taggant was coated onto, which altered the relative strength of the signals measured for the Sr compared to the Co when the measurement was carried out from different sides of the fabric.

TABLE 27

| | | Percentage composition | | | |
|---|---|---|---|---|---|
| | | | | Fabric with | Fabric with |
| Element/ | | Fabric only | Fabric only | ZSM-5/Co/Sr | ZSM-5/Co/Sr |
| Compound | XRF | control, | control, | taggant, front | taggant, back |
| identity | Measurement | front side | back side | side | side |
| Al₂O₃ | 1 | — | — | 3.0 | 0.4 |
| | 2 | — | — | 3.9 | — |
| SiO₂ | 1 | 0.17 | 0.17 | 57.2 | 24.9 |
| | 2 | 0.19 | 0.19 | 68.0 | 21.2 |
| Co | 1 | — | — | 0.197 | 0.235 |
| | 2 | — | — | 0.294 | 0.210 |
| Sr | 1 | — | — | 0.093 | 0.189 |
| | 2 | — | — | 0.133 | 0.165 |

TABLE 28

| | XRF | | | | Average |
|---|---|---|---|---|---|
| | Measure- | Strontium | Cobalt | Sr:Co | Sr:Co |
| Sample | ment | (%) | (%) | Ratio | Ratio |
| Red cotton fabric | 1 | 0.093 | 0.197 | 1:2.1 | 1:2.2 |
| with ZSM-5/Co/Sr | 2 | 0.133 | 0.294 | 1:2.2 | |
| taggant, front side | | | | | |
| Red cotton fabric | 1 | 0.189 | 0.235 | 1:1.2 | 1:1.3 |
| with ZSM-5/Co/Sr | 2 | 0.165 | 0.210 | 1:1.3 | |
| taggant, back side | | | | | |

### Example 10—Metal Zeolite Taggants Encased in Polyethylene Film

To prepare the samples, 0.03 g of ZSM-5/Co/Sr taggant was placed inside a polyethylene bag that had a thickness of 0.001 in. A heat gun was then used to anneal the polyethylene film so that it shrunk and enclosed the taggant sample. The samples are shown in FIG. 19, wherein (a) is a polyethylene bag only control sample and (b) is the polyethylene bag with ZSM-5/Co/Sr taggant after sealing with a heat gun.

For each sample, a total of two XRF measurements were made. The sample was repositioned after the first measurement for a second XRF measurement to measure a different region of the sample.

The percent composition of the chemical species and elements that were detected by XRF in the different samples is shown in Table 29. As shown in Table 29, there was no Co or Sr detected in the control sample, while both were readily detected in the sample containing the taggant.

TABLE 29

| | | Percentage composition | |
|---|---|---|---|
| Element/ | | Polyethylene | |
| Compound | XRF | bag only | Polyethylene bag with |
| identity | Measurement | (Control) | ZSM-5/Co/Sr taggant |
| Al₂O₃ | 1 | — | 0.4 |
| | 2 | — | 0.2 |
| SiO₂ | 1 | 0.9 | 33.2 |
| | 2 | 0.9 | 30.4 |
| Co | 1 | — | 0.495 |
| | 2 | — | 0.499 |
| Sr | 1 | — | 0.454 |
| | 2 | — | 0.445 |

The elements Sr and Co were detected in the sample with an average Sr:Co ratio of 1:1.1, as shown in Table 30. This demonstrates that these taggants can be readily detected when encapsulated using thin plastic films enabling their use in a wide variety of objects. Further, this demonstrates that metal-zeolite taggants could be used as anti-counterfeiting measure in plastic banknotes that are used in several countries.

TABLE 30

| | XRF | | | | Average |
|---|---|---|---|---|---|
| | Measure- | Strontium | Cobalt | Sr:Co | Sr:Co |
| Sample | ment | (%) | (%) | Ratio | Ratio |
| ZSM-5/Co/Sr | 1 | 0.454 | 0.495 | 1:1.1 | 1:1.1 |
| taggant encased in | 2 | 0.445 | 0.499 | 1:1.1 | |
| polyethylene | | | | | |

### Example 11—XRF Analysis of the Taggant

A sample of the ZSM-5/Co/Sr taggant used in Examples 7-10, by itself, was analyzed by XRF using a powder sample holder covered in a Prolene film 0.00016 inches thick. The Sr and Co percentages and the Sr:Co ratio are shown in Table 31.

TABLE 31

| | XRF | | | | Average |
|---|---|---|---|---|---|
| | Measure- | Strontium | Cobalt | Sr:Co | Sr:Co |
| Sample | ment | (%) | (%) | Ratio | Ratio |
| ZSM-5/Co/Sr | 1 | 0.562 | 0.458 | 1:0.81 | 1:0.85 |
| taggant in sample | 2 | 0.533 | 0.477 | 1:0.89 | |
| holder sealed with | | | | | |
| Prolene film | | | | | |

The ZSM-5/Co/Sr taggant sample covered in Prolene film had a Sr:Co ratio of 1:0.85, with a lower proportion of Co than the measurements of the taggant incorporated into the ink, toner, fabric or polyethylene film materials as demonstrated in Examples 7-10. The Sr:Co ratio of the taggant sample covered in Prolene was closest to the value for the taggant sample encased in polyethylene film. The Prolene film is the standard material used to cover powder samples for XRF measurements, and has the least interaction with the X-rays used in the excitation beam and the fluorescent X-rays emitted by the sample being analyzed. This indicates that the measured ratio of the metal ions in the taggant will vary the least due to matrix effects when the taggant is incorporated into a material that has little interaction with X-rays. However, even when the taggant was incorporated into more complex materials where it was only a minor portion of the sample the Sr:Co metal ion ratio could still be measured and the variation in the ratio across substantially different environments was moderate, the maximum difference in the proportion of Co to Sr across all materials tagged was a factor of two.

The elements cobalt and strontium differ by 11 in their atomic number, which means that there is a substantial difference in the energy of the fluorescent X-rays that they emit. Hence, it is not surprising that this combination of metal ions in the taggant shows noticeable variation in the ratios of the metals measured by XRF when the taggant was placed in different environments. This means that consideration will need to be given to the extent of matrix interactions with X-rays when choosing the combinations of metals to use in different taggant applications. Metals that are closer together in atomic number will produce a greater number of taggant compositions that can be distinguished from each other in applications where the object they are tagging will itself causes substantial absorption or scattering of X-rays.

### Example 12—Evaluation of Various Encapsulating Materials

To prepare the samples, 0.44 g of lanthanum(III), 1.00 g of either ZMS-5, Zeolite Y, or Zeolite Ferrierite, and 20 mL of distilled water were refluxed, with stirring for one and a half hours. The heat was turned off, the flask allowed to cool, and the solution was then vacuum filtered. The process resulted in 1.00 g of a white solid for the ZSM-5/La sample, 1.02 g of a white solid for the Zeolite Y/La sample, and 0.95 g of the Ferrierite/La sample.

XRF measurements of the powdered samples are shown in Table 32. Two XRF measurements were taken, and the sample repositioned between measurements. Zeolite Y adsorbed greater amounts of the La³⁺ cation than the two other zeolites. The amount of lanthanum detected in the Zeolite Y/La sample were approximately four and ten times greater than the amounts detected in the ZSM-5/La and Ferrierite/La samples, respectively. This shows that the amount of metal cation adsorbed in forming a metal-zeolite taggant depends upon the choice of zeolite type used and that with the appropriate choice of zeolite for making the taggant it is feasible to use larger metal cations such as La³⁺.

TABLE 32

| | XRF | Al₂O₃ | SiO₂ | La | Average Metal |
|---|---|---|---|---|---|
| Sample | Measurement | Percentage | Percentage | Percentage | Percentage |
| ZSM-5/La | 1 | 1.9 ± 0.3 | 45.4 ± 0.6 | 0.063 ± 0.010 | 0.063 |
| | 2 | 1.9 ± 0.3 | 45.4 ± 0.6 | 0.062 ± 0.010 | |
| Zeolite Y/La | 1 | 5.0 ± 0.4 | 51.5 ± 0.6 | 0.273 ± 0.013 | 0.236 |
| | 2 | 5.1 ± 0.4 | 50.3 ± 0.6 | 0.199 ± 0.011 | |
| Ferrierite/La | 1 | 4.9 ± 0.4 | 71.2 ± 0.8 | 0.025 ± 0.007 | 0.024 |
| | 2 | 4.8 ± 0.3 | 71.1 ± 0.8 | 0.023 ± 0.007 | |

### Example 13—Evaluation of Large Cation Taggants

Four samples were prepared to evaluate taggants with larger cations.

The first is a reaction of 1.0×10⁻³ mol La and 1.0×10⁻⁴ mol Ce per g Zeolite Y. 0.44 g lanthanum(III) nitrate, 1.00 g Zeolite Y, 0.054 g ammonium cerium(IV) nitrate, and 20 mL distilled water were refluxed with stirring for one and half hours. The heat was turned off, and the flask was allowed to cool. The yellow solution was vacuum filtered, and then set aside to air dry. The dried product was a cream solid, yield: 1.0184 g.

The second sample was a reaction of 1.0×10⁻³ mol La and 5.0×10⁻⁴ mol Ce per g Zeolite Y. 0.47 g Lanthanum(III) nitrate, 1.00 g Zeolite Y, 0.28 g ammonium cerium(IV) nitrate, and 20 ml distilled water were refluxed with stirring for one and half hours. The heat was turned off, and the flask was allowed to cool. The yellow solution was vacuum filtered and air dried. The dried product was a cream solid, yield: 1.0812 g.

The third sample was a reaction of 1.0×10⁻⁴ mol La and 1.0×10⁻³ mol Ce per g Zeolite Y. 0.42 g Lanthanum(III) nitrate, 1.00 g Zeolite Y, 0.614 g ammonium cerium(IV) nitrate, and 20 ml distilled water were refluxed with stirring for one and half hours. The heat was turned off, and the flask was allowed to cool. The yellow solution was vacuum filtered and air dried. The dried product was a dried cream solid, yield: 1.1810 g.

The fourth sample was a reaction of 1.0×10⁻³ mol La, 5.0×10⁻⁴ mol Ce, and 1.0×10⁻⁴ mol Co per g Zeolite Y. 0.44 g Lanthanum(III) nitrate, 0.30 g ammonium cerium(IV) nitrate, 0.029 g cobalt(II) nitrate hexahydrate, 1.00 g Zeolite Y, and 20 mL distilled water were refluxed with stirring for one and half hours. The heat was turned off, and the flask was allowed to cool. The yellow solution was vacuum filtered and air dried. The dried product was a cream solid, yield: 1.0953 g.

XRF measurements of the powdered samples are shown in Table 33. Two XRF measurements were taken, and the sample repositioned between measurements. The XRF data on the zeolite Y/La/Ce samples show that metal-zeolite taggants with differing ratios of lanthanum to cerium can be prepared when different proportions of the La³⁺ and Ce⁴⁺ cations are reacted with the zeolite. La³⁺ and Ce⁴⁺ are larger cations, and the preparation of metal-zeolite taggants with different metal ion ratios using these cations shows that a very large number of unique metal-zeolite taggants based on different combinations and ratios of metal ions can be made. The ratio of the metal ions in the metal-zeolite taggants differs from the ratio of the metal ions used in the reaction with the zeolite because of the differing relative adsorption affinities of the metal ions for the zeolite. The XRF data on the zeolite Y/La/Ce/Co sample) demonstrates the combination of lanthanide metal ions with transition metal ions in a metal-zeolite taggant and detection by XRF. This shows that many metal-zeolite taggant combinations can be made by combining metals from different regions of the periodic table.

TABLE 33

| | XRF | | | | Metal Ratio |
|---|---|---|---|---|---|
| Sample | Measurement | La % | Ce % | Co % | La:Ce:Co |
| 1.0 × 10⁻³ La | 1 | 0.225 ± 0.012 | 0.086 ± 0.009 | <LOD | 1:0.38:0 |
| 1.0 × 10⁻⁴ Ce | 2 | 0.186 ± 0.011 | 0.064 ± 0.008 | <LOD | 1:0.34:0 |
| 1.0 × 10⁻³ La | 1 | 0.292 ± 0.015 | 0.612 ± 0.017 | <LOD | 1:2.1:0 |
| 5.0 × 10⁻⁴ Ce | 2 | 0.202 ± 0.012 | 0.445 ± 0.014 | <LOD | 1:2.2:0 |
| 1.0 × 10⁻⁴ La | 1 | 0.021 ± 0.014 | 2.02 ± 0.03 | <LOD | 1:96:0 |
| 1.0 × 10⁻³ Ce | 2 | <LOD | 1.58 ± 0.03 | <LOD | not determinable |
| 1.0 × 10⁻³ La | 1 | 0.248 ± 0.015 | 0.659 ± 0.019 | 0.039 ± 0.003 | 1:2.7:0.16 |
| 5.0 × 10⁻⁴ Ce | 2 | 0.178 ± 0.012 | 0.413 ± 0.015 | 0.040 ± 0.003 | 1:2.3:0.22 |
| 1.0 × 10⁻⁴ Co | | | | | |

<LOD=less than the limit of detection

### Example 14—Evaluation of Taggants Coated with Polymer in Extreme Environments

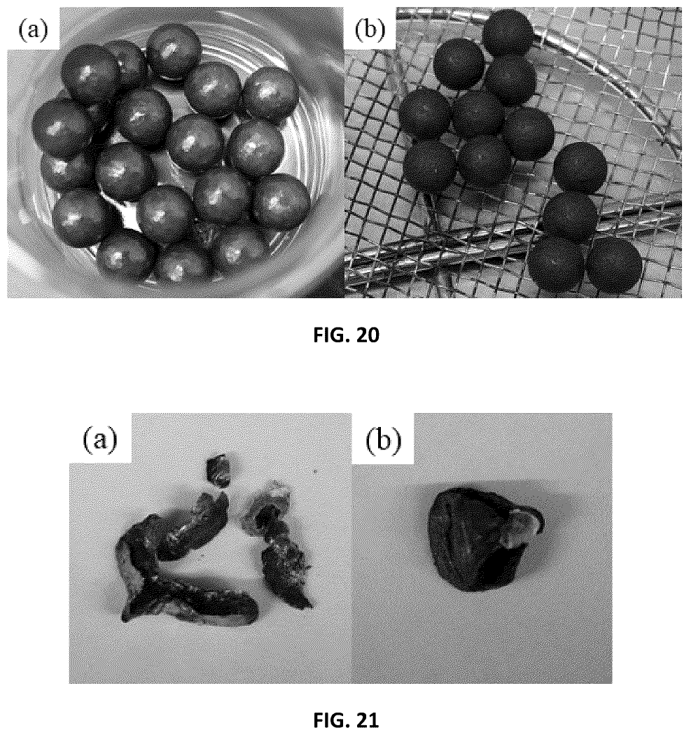

To create polymer coated control samples, nineteen lead bullets, about 220 g, were mixed with a solution of 1.0 mL Hi-Tek Supercoat powder in acetone, 20% w/v, by gently tumbling them for about 4 minutes. Hi-Tek Supercoat is a polymer coating applied to lead bullets to, among other things, reduce fragmenting and eliminate lead fouling and smoke. The coated bullets were put in a wire basket and left exposed to the air until the acetone had evaporated. The bullets were placed in an oven at 195° C. for 10 minutes then removed and cooled to room temperature. This procedure was repeated two more times using 1.0 mL of the solution of Hi-Tek Supercoat powder in acetone each time to add a second and third layer of the polymer coating onto the bullets. This coated control sample is shown in photograph (a) in FIG. 20.

To create the bullets with taggants, nineteen lead bullets, about 220 g, were mixed with a solution of 1.0 mL Hi-Tek supercoat powder in acetone, 20% w/v, and 0.10 g ZSM-5/Co/Sr taggant by gently tumbling them for about 4 minutes. The coated bullets were put in a wire basket and left exposed to the air until the acetone had evaporated. The bullets were placed in an oven at 195° C. for 10 minutes then removed and cooled to room temperature. This procedure was repeated two more times using 1.0 mL of the solution of Hi-Tek supercoat powder in acetone and 0.10 g ZSM-5/Co/Sr taggant each time to add a second and third layer of the polymer coating plus taggant onto the bullets. This polymer coated+ZSM-5/Co/Sr sample is shown in photograph (b) in FIG. 20.

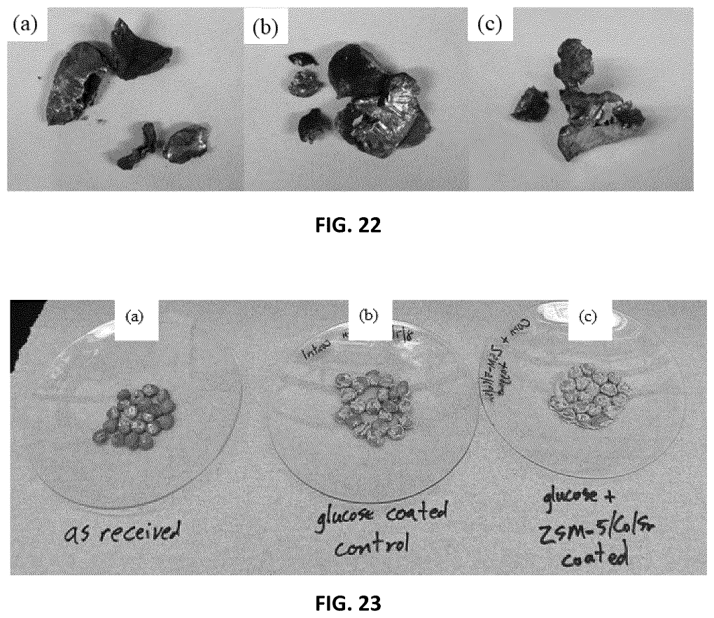

The bullets were fired from a black powder pistol into thick books. A separate book was used as the target for each bullet that was fired. Photographs of control bullets are shown in FIG. 21 and photographs of bullets with the taggant are shown in FIG. 22. As shown in FIG. 21 and FIG. 22, The amount of fragmentation was similar for the polymer coated control bullets and the polymer+ZSM-5/Co/Sr taggant coated bullets. This shows that the addition of the taggant to the polymer coating did not substantially alter its ability to limit the fragmentation of the lead projectile when it impacted the thick books used as targets.

XRF measurements were taken of the pages of the book where the bullet penetrated it after the bullet had been removed. This data is shown in Table 34. There were not any significant differences between the book targets for the controls and bullets with the Co/Sr taggant in the polymer coating. The cobalt was not detected in any of the samples, and the amounts of strontium detected are low. This is consistent with the ZSM-5/Co/Sr taggant being retained as part of the coating on the bullet when it hits the target

TABLE 34

| | Strontium | Cobalt | Lead |
|---|---|---|---|
| Sample | % | % | % |
| Coated Control 1 | 0.0015 ± 0.0004 | <LOD | 0.38 ± 0.01 |
| Coated Control 2 | 0.0029 ± 0.0005 | <LOD | 0.032 ± 0.002 |
| Coated Co/Sr Taggant 1 | 0.0016 ± 0.0004 | <LOD | 0.004 ± 0.001 |
| Coated Co/Sr Taggant 2 | 0.0023 ± 0.0005 | <LOD | 0.008 ± 0.002 |
| Coated Co/Sr Taggant 3 | 0.0019 ± 0.0005 | <LOD | 0.290 ± 0.009 |

The bullet pieces were analyzed by the XRF instrument after removal from the book. Duplicate measurements were made of the bullets, using a different position of the bullet for the second measurement. The XRF results are shown in Table 35. There were meaningful differences between the Hi-Tek polymer control bullets and the bullets that had the ZSM-5/Co/Sr taggant added to the polymer coating. There was no cobalt detected in the control samples, and the strontium levels were low in the controls. In the samples that were labeled with the taggant the cobalt was readily detected and the strontium was detected at similar levels, with the strontium levels being much higher than the amounts detected in the control samples. The ability to reliably detect the taggant when it is blended with a bullet polymer coating and the bullet fired is an important result showing the utility of the taggant in extreme environments.

TABLE 35

| | XRF | Strontium | Cobalt | Lead | Sr:Co |
|---|---|---|---|---|---|
| Sample | Measurement | % | % | % | Ratio |
| Control bullet 1 | 1 | 0.0039 ± 0.0014 | <LOD | 61.9 ± 0.5 | |
| | 2 | 0.0037 ± 0.0013 | <LOD | 60.8 ± 0.5 | |
| Control bullet 2 | 1 | 0.0050 ± 0.0014 | <LOD | 47.9 ± 0.4 | |
| | 2 | 0.0050 ± 0.0015 | <LOD | 47.1 ± 0.4 | |
| Co/Sr taggant | 1 | 0.0335 ± 0.0023 | 0.0305 ± 0.0028 | 48.2 ± 0.4 | 1:0.91 |
| bullet 1 | 2 | 0.0333 ± 0.0023 | 0.0305 ± 0.0029 | 46.9 ± 0.4 | 1:0.92 |
| Co/Sr taggant | 1 | 0.0161 ± 0.0020 | 0.0118 ± 0.0020 | 57.9 ± 0.5 | 1:0.73 |
| bullet 2 | 2 | 0.0196 ± 0.0020 | 0.0165 ± 0.0024 | 52.1 ± 0.5 | 1:0.84 |
| Co/Sr taggant | 1 | 0.0252 ± 0.0021 | 0.0257 ± 0.0029 | 41.6 ± 0.5 | 1:1.02 |
| bullet 3 | 2 | 0.0264 ± 0.0021 | 0.00256 ± 0.0029 | 44.2 ± 0.5 | 1:0.97 |

The Sr:Co ratio varied from 1:0.7 to 1:1.0 for the different measurements on the bullets labeled with the taggant. The variation in the ratio is mostly due to the uncertainty in the small amounts of Co and Sr measured. The amounts of Co and Sr measured were lower than in measurements of some other tagged objects because only a single bullet was measured and the shapes of the bullets were irregular after hitting the targets, which limited how well the XRF instrument could be aligned with the sample and the area irradiated by the excitation beam of the instrument may have been only partially occupied by the pieces of the bullet. This shows that the metal-zeolite taggant is stable under the extreme conditions of firing a bullet, and that the metal ion ratio can be measured in the taggant on a single bullet.

### Example 15—Evaluation of Taggants on Corn Kernels

To create glucose coated control kernels, twenty corn kernels were added to a solution of 1.50 g glucose dissolved in 3.0 mL distilled water. The corn kernels were mixed with the glucose solution for a few seconds and then transferred to a watch glass and left to dry overnight. A photograph of the kernels as received is FIG. 23 on the left and a photograph of glucose coated control samples is shown in the middle of FIG. 23.

To create samples with the taggant, 0.40 g ZSM-5/Co/Sr taggant and 1.01 g glucose were combined with 2.0 mL distilled water and gently mixed for about 5 minutes to dissolve the glucose. Twenty corn kernels were added and mixed for a few seconds. The coated kernels were transferred to a watch glass and left to dry overnight. A photograph of the glucose+ZSM-5/Co/Sr taggant coated samples is shown on the right of FIG. 23.

Five unplanted corn kernels from each treatment condition (as received, glucose coated control, and glucose+ZSM-5/Co/Sr coated) were used for XRF measurements. The position of the kernels was rearranged after the first measurement and a second measurement was made for each sample. The XRF data is shown in Table 36. As shown in Table 36, the corn kernels were successfully coated with the ZSM-5/Co/Sr metal zeolite taggant. The Co and Sr were detected by XRF on the kernels coated with the taggant, while no Co or Sr were detected on the kernels tested directly from the seed packet without anything being done to them or on the glucose coated control kernels. The Sr:Co ratios from the two measurements of the kernels coated with the ZSM-5/Co/Sr taggant were quite consistent, even though the measured percentages of Co and Sr different. The percentages of Co and Sr measured differed probably because different proportions of the small seeds were in the area irradiated by the instrument for the XRF measurement, and there may have been different amounts of taggant on individual kernels that were positioned in the irradiation region for the two measurements. This shows that the ratios of the metals within the metal-zeolite taggant can be reliably measured and used as an identifier when the signal strength changes due to differing amounts of material being used in the testing of small samples.

TABLE 36

| | XRF | | | |
|---|---|---|---|---|
| Sample | Measurement | Strontium % | Cobalt % | Sr:Co Ratio |
| As Received | 1 | <LOD | <LOD | |
| | 2 | <LOD | <LOD | |
| Glucose Coated | 1 | <LOD | <LOD | |
| Control | 2 | <LOD | <LOD | |
| Glucose + ZSM- | 1 | 0.0935 ± 0.0023 | 0.108 ± 0.005 | 1:1.16 |
| 5/Co/Sr Taggant | 2 | 0.0305 ± 0.0014 | 0.0323 ± 0.0027 | 1:1.06 |
| Coated | | | | |

Ten corn kernels from each seed treatment condition (as received, glucose coated control, and glucose+ZSM-5/Co/Sr coated) were planted in potting mix in small plastic cups. The cups had a small hole in the bottom to allow excess water to drain out. The planted kernels had not been irradiated by the X-ray beam in XRF measurements. The kernels were covered with 2.0-2.5 cm of potting mixture. The planted seeds were placed under fluorescent lights that were on 24 hours a day. The soil was watered with tap water periodically, when small parts of the top surface were dried out.

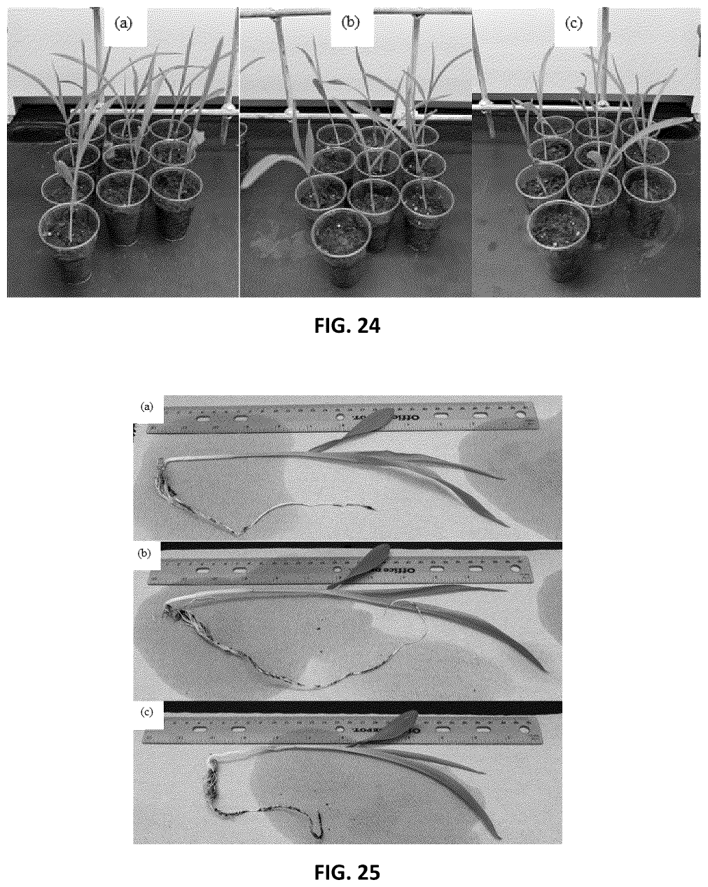

The corn kernels with the glucose+ZSM-5/Co/Sr taggant coating had similar germination rates to control seeds that had not been exposed to the metal-zeolite taggant. Germination rates are shown in Table 37. Photographs of the corn plants on day 11 after planting are shown in FIG. 24. In FIG. 24, the corn plants from the kernels used as received are shown on the left (a), the corn plants grown from glucose treated kernels are shown in the middle (b), and corn plants grown from kernels with the glucose+ZSM-5/Co/Sr taggant are shown on the right (c). This shows that seeds remain viable after treatment with metal-zeolite taggants.

TABLE 37

| | Day 4 | Day 7 | Day 8 |
|---|---|---|---|
| Kernel Type | Germination | Germination | Germination |
| As Received | 0/10 | 10/10 | 10/10 |
| Glucose Coated Control | 0/10 | 8/10 | 8/10 |
| Glucose + ZSM-5/Co/Sr | 0/10 | 8/10 | 9/10 |
| Taggant Coated | | | |

On day 11 of the corn kernel germination test XRF measurements were made of the corn plants. One plant grown from each seed treatment condition (as received, glucose coated control, and glucose+ZSM-5/Co/Sr coated) was analyzed. The stem of the plant was bent so that it could be folded up and placed inside the small sample safety shield. The plants were arranged so that it was mostly the stem (the thickest part of the plants) in the region that was irradiated by the X-ray beam. The plant was repositioned and a second measurement was made. The corn kernel was detached from the roots and stem of a plant of the glucose+ZSM-5/Co/Sr batch and the side that did not have the root and stem coming out of it was placed facing the XRF instrument to measure the X-ray fluorescence because white material that appeared to be the taggant was still visible on it. The kernel was repositioned, with the same side facing the instrument, and a second measurement was made. XRF data is shown in Table 38.

TABLE 38

| | XRF | Strontium | Cobalt | Sr:Co |
|---|---|---|---|---|
| Sample | Measurement | % | % | Ratio |
| Stem From As | 1 | <LOD | <LOD | |
| Received Kernel | 2 | <LOD | <LOD | |
| Stem From Glucose | 1 | <LOD | <LOD | |
| Coated Control Kernel | 2 | <LOD | <LOD | |
| Stem From Glucose + | 1 | <LOD | <LOD | |
| ZSM-5/Co/Sr taggant | 2 | <LOD | <LOD | |
| Coated Kernel | | | | |
| Kernel Separated | 1 | 0.0063 ± 0.0007 | 0.0173 ± 0.0019 | 1:2.7 |
| From Plant Grown | 2 | 0.0065 ± 0.0007 | 0.0190 ± 0.0020 | 1:2.9 |
| From Glucose + ZSM- | | | | |
| 5/Co/Sr Taggant | | | | |
| Treated Kernel | | | | |

The corn plants uprooted for XRF testing on day 11 still showed distinguishable kernels as shown in FIG. 25, therefore A kernel from a plant grown from the glucose+ZSM-5/Co/Sr coated kernel was also analyzed by XRF. In FIG. 25 the plant grown from a kernel as received is shown in the photograph at the top (a), the plant from a glucose treated control kernel is shown in the middle photograph (b), and the plant grown from a glucose+ZSM-5/Co/Sr taggant is shown in the bottom photograph (c). The stem of the plant grown from the glucose+ZSM-5/Co/Sr coated kernel did not contain detectable levels of Co or Sr, which indicated that the level of uptake, if any, of the metals from the taggant into the growing plant's tissues was low. As expected, no Co or Sr were detected in the plant grown from the kernel used as received or the plant grown from the glucose coated control kernel. The Co and Sr were detected by XRF on the seed separated from the plant grown from the taggant coated kernel. The detection of the taggant on the seed on day 11 after planting when it had been watered every 2-3 days shows the robustness of the taggant system. The levels of Co and Sr detected on the seed taken from the plant were lower than in the previous measurements because only a single seed was used in the XRF measurement. The Sr:Co ratio on the seed from the day 11 plant differed from the value for the taggant coated seeds that were not planted. This difference indicates that there may have been some leaching of Sr from the taggant in the soil environment, however this was a slow process, as both Co and Sr were still detected on day 11. If it is desired to identify tagged seeds after they have been planted, the potential of changes in the taggant on the planted seed can be greatly reduced by using a taggant with an additional coating on it, as we have shown that coatings which greatly reduce metal leaching from the zeolite can be added to the taggant particles.

The present disclosure is further defined by the following numbered embodiments.
1. An identification system comprising: a taggant comprising at least two different metal elements adsorbed into an inert encapsulating material; wherein the combination of metal elements and/or proportion of metal elements is an identifying marker of the taggant.
2. The identification system of embodiment 1, wherein the proportion of metal elements is the identifying marker of the taggant.
3. The identification system of embodiment 1, wherein the combination of metal elements is the identifying marker of the taggant.
4. The identification system of any one of embodiments 1-3, wherein the inert encapsulating material comprises a carbon nanotube, clay, fullerene, graphite, graphene, a polymer, a porous metal oxide, and/or a zeolite.
5. The identification system of any one of embodiments 1-4, wherein the inert encapsulating material is a zeolite.
6. The identification system of any one of embodiments 1-5, wherein the metal elements comprise metal ions.
7. The identification system of any one of embodiments 1-6, wherein the relative concentration of the different metal elements is varied by about 5% or more, or 10% or more, to create the identifying marker of the taggant.
8. The identification system of any one of embodiments 1-7, wherein the proportion of metal elements is the identifying marker of the taggant, and wherein the taggant comprises from 2 different metal elements to 10 different metal elements.
9. The identification system of any one of embodiments 1-8, wherein the combination of metal elements is the identifying marker of the taggant, and wherein the taggant comprises 3 or more different elements.
10. The identification system of any one of embodiments 1-9, wherein the identification system is non-toxic.
11. The identification system of any one of embodiments 1-10, further comprising an inert coating on at least a portion of the taggant.
12. The identification system of embodiment 11, wherein the inert coating reduces variation in the identifying marker of the taggant.
13. The identification system of embodiment 11, wherein the inert coating reduces variation in the identifying marker of the taggant in a harsh environment.
14. The identification system of embodiment 13, wherein the harsh environment comprises a pH of less than about 5 or a pH of greater than about 9.
15. The identification system of any one of embodiments 13-14, wherein the harsh environment comprises a temperature of greater than about 50° C.
16. The identification system of any one of embodiments 13-15, wherein the harsh environment comprises a temperature of greater than about 100° C.
17. The identification system of any one of embodiments 13-16, wherein the harsh environment is highly oxidizing or highly reducing.
18. The identification system of any one of embodiments 11-17, wherein the coating comprises carbon, polymer, plastic, oxidation and/or acid resistant metal, metal oxide, and/or metalloid oxide.
19. The identification system of any one of embodiments 1-18, wherein the identification system comprises from about 1 wt-% to about 50 wt-% of the taggant.
20. The identification system of any one of embodiments 1-19, wherein the identification system is a thin layer on at least a portion of an object to be identified.
21. The identification system of any one of embodiments 1-20, wherein the identification system is incorporated into a coating material on at least a portion of an object to be identified.
22. The identification system of any one of embodiments 1-21, wherein the identification system is incorporated into a paint, an ink, a pigment, a dye, a polymer, a plastic, an opacifier, and/or an adhesive on at least a portion of an object to be identified.
23. The identification system of any one of embodiments 20-22, wherein the identification system is less than 1 mm in thickness.
24. The identification system of any one of embodiments 20-22, wherein the identification system is more than 1 mm in thickness.
25. The identification system of any one of embodiments 1-19, wherein the identification system is enclosed between two layers.
26. The identification system of embodiment 25, wherein the layers comprise a plastic, and/or a polymer.
27. The identification system of any one of embodiments 25-26, wherein the layers comprise polyethylene.
28. The identification system of any one of embodiments 1-27, wherein the metal elements comprise calcium, cerium, chromium, cobalt, copper, iron, lanthanum, manganese, nickel, and/or strontium.
29. A method of making the identification system of any one of embodiments 1-28 comprising: adsorbing at least two different metal elements into an inert encapsulating material, wherein a pre-selected combination of metal elements and/or a pre-selected proportion of metal elements is the identifying marker of the taggant.
30. The method of embodiment 29, wherein the different metal elements are pre-selected based on a pre-selected surface of an object to be identified.
31. The method of any one of embodiments 29-30, wherein the different metal elements are pre-selected based on the thickness of the identification system.
32. An anticounterfeiting system comprising the identification system of any one of embodiments 1-28.
33. A message encryption system comprising the identification system of any one of embodiments 1-28.
34. An authentication system comprising the identification system of any one of embodiments 1-28.
35. An anti-piracy system comprising the identification system of any one of embodiments 1-28.
36. An object comprising the identification system of any one of embodiments 1-28.
37. The object of embodiment 36, wherein the object comprises currency, ballistics, an explosive, a shipment, a parcel, a pharmaceutical, food, a crop, a document, a letter, a vehicle, an animal, a label, packaging, an identification card, and/or a good in commerce.
38. A method of identifying an object comprising: applying the identification system of any one of embodiments 1-28 to an object; and detecting the combination of metal elements and/or proportion of metal elements of the taggant.
39. The method of embodiment 38, wherein the detecting comprises emission of electromagnetic radiation that is characteristic of the metal elements of the taggant.
40. The method of embodiment 38, wherein the detecting comprises absorbance of electromagnetic radiation that is characteristic of the metal elements of the taggant.
41. The method of any one of embodiments 38-40, wherein the detecting is non-destructive to the taggant.
42. The method of any one of embodiments 38-41, wherein the detecting is conducted on-site.
43. The method of any one of embodiments 38-42, wherein the detecting comprises x-ray fluorescence, energy dispersive x-ray analysis, particle induced x-ray emission, synchrotron radiation induced x-ray emission, atomic absorption spectroscopy, atomic emission spectroscopy, optical emission spectroscopy, mass spectrometry, inductively coupled plasma mass spectrometry, and/or inductively coupled plasma atomic emission spectroscopy.
44. The method of any one of embodiments 38-42, wherein the method comprises detecting trace levels of the metal elements.

The above disclosure is intended to be illustrative and not exhaustive. This description will suggest many variations and alternatives to one of ordinary skill in this art. All these alternatives and variations are intended to be included within the scope of the following claims where the term “comprising” means “including, but not limited to”. Those familiar with the art may recognize other equivalents to the specific embodiments described herein which equivalents are also intended to be encompassed by the following claims

1. An identification system comprising:
a taggant comprising at least two different metal elements adsorbed into an inert encapsulating material;
wherein the combination of metal elements and/or proportion of metal elements is an identifying marker of the taggant.

2. The identification system of claim 1, wherein the inert encapsulating material comprises a carbon nanotube, clay, fullerene, graphite, graphene, a polymer, a porous metal oxide, and/or a zeolite, and the metal elements comprise metal ions.

3. The identification system of claim 1, wherein the relative concentration of the different metal elements is varied by about 5% or more to create the identifying marker of the taggant, and wherein the proportion of metal elements is the identifying marker of the taggant, and wherein the taggant comprises from 2 different metal elements to 10 different metal elements.

4. The identification system of claim 1, wherein the combination of metal elements is the identifying marker of the taggant, and wherein the taggant comprises 3 or more different elements.

5. The identification system of claim 1, wherein the identification system is non-toxic.

6. The identification system of claim 1, further comprising an inert coating on at least a portion of the taggant.

7. The identification system of claim 1, wherein the coating comprises carbon, polymer, plastic, oxidation and/or acid resistant metal, metal oxide, and/or metalloid oxide.

8. The identification system of claim 1, wherein the identification system is a thin layer on at least a portion of an object to be identified, and/or wherein the identification system is incorporated into a coating material on at least a portion of an object to be identified.

9. The identification system of claim 1, wherein the identification system is incorporated into a paint, an ink, a pigment, a dye, a polymer, a plastic, an opacifier, and/or an adhesive on at least a portion of an object to be identified.

10. The identification system of claim 1, wherein the identification system is less than 1 mm in thickness, or greater than 1 mm in thickness.

11. The identification system of claim 1, wherein the identification system is enclosed between two layers, wherein the layers comprise a plastic, and/or a polymer.

12. The identification system of claim 1, wherein the metal elements comprise calcium, cerium, chromium, cobalt, copper, iron, lanthanum, manganese, nickel, and/or strontium.

13. An anticounterfeiting system, a message encryption system, an authentication system, an antipiracy system, and/or an object comprising the identification system of claim 1.

14. The object of claim 13, wherein the object comprises currency, ballistics, an explosive, a shipment, a parcel, a pharmaceutical, food, a crop, a document, a letter, a vehicle, an animal, a label, packaging, an identification card, and/or a good in commerce.

15. A method of identifying an object comprising:
applying a taggant to an object, wherein the taggant comprises at least two different metal elements adsorbed into an inert encapsulating material comprising a carbon nanotube, clay, fullerene, graphite, graphene, a polymer, a porous metal oxide, and/or a zeolite;
wherein the combination of metal elements and/or proportion of metal elements is an identifying marker of the taggant; and
detecting the combination of metal elements and/or proportion of metal elements of the taggant.

16. The method of claim 15, wherein the detecting comprises emission of electromagnetic radiation that is characteristic of the metal elements of the taggant, and/or wherein the detecting comprises absorbance of electromagnetic radiation that is characteristic of the metal elements of the taggant.

17. The method of claim 15, wherein the detecting is non-destructive to the taggant.

18. The method of claim 15, wherein the detecting is conducted on-site.

19. The method of claim 15, wherein the detecting comprises x-ray fluorescence, energy dispersive x-ray analysis, particle induced x-ray emission, synchrotron radiation induced x-ray emission, atomic absorption spectroscopy, atomic emission spectroscopy, optical emission spectroscopy, mass spectrometry, inductively coupled plasma mass spectrometry, and/or inductively coupled plasma atomic emission spectroscopy.

20. The method of claim 15, wherein the method comprises detecting trace levels of the metal elements.
